(19) United States
(12) Patent Application Publication
(10) Pub. No.: US 2025/0326421 A1
(43) Pub. Date: Oct. 23, 2025

(54) FOLDABLE CARRIER, CARRIER FRAME OF CHILD CARRYING DEVICE, AND CHILD CARRYING DEVICE

(71) Applicant: WONDERLAND SWITZERLAND AG, Steinhausen (CH)

(72) Inventor: Haitao WU, Dongguan, Guangdong (CN)

(73) Assignee: WONDERLAND SWITZERLAND AG, Steinhausen (CH)

(21) Appl. No.: 18/873,219

(22) PCT Filed: Jun. 12, 2023
(86) PCT No.: PCT/EP2023/065666

§ 371 Date: Dec. 9, 2024

(30) Foreign Application Priority Data
Jun. 10, 2022 (CN) 202210655920.1
Aug. 4, 2022 (CN) 202210933515.1
Aug. 19, 2022 (CM) 202211000548.7

(51) Int. Cl. B62B 7/10; B62B 7/14; B62B 9/10

(52) U.S. Cl. CPC B62B 7/10; B62B 7/142; B62B 7/145; B62B 9/104; B62B 2205/20

(57) ABSTRACT

The present application relates to a foldable carrier, a carrier frame of a child carrying device, and a child carrying device. The foldable carrier includes a seat assembly, an armrest assembly, a backrest assembly, a linkage assembly, and a locking member. The armrest assembly is pivotable relative to the seat assembly and movable between a folded position and an unfolded position, and the armrest assembly is provided with a locking portion. The backrest assembly has a folded position and an unfolded position. The linkage assembly is movably connected to the backrest assembly. One end of the locking member is pivotally connected to the linkage assembly, the other end of the locking member is capable of being fitted with the locking portion, and the backrest assembly is folded in a direction approaching the armrest assembly to drive, through the linkage assembly, the locking member to be separated from the locking portion.

### CROSS-REFERENCE TO RELATED APPLICATIONS

This application is a National Stage application of PCT/EP2023/065666, filed on Jun. 12, 2023, which claims priority to Chinese Patent Application No. 202211000548.7, filed on Aug. 19, 2022, Chinese Patent Application No. 202210933515.1, filed on Aug. 4, 2022, and Chinese Patent Application No. 202210655920.1, filed on Jun. 10, 2022, all of which are incorporated herein by reference in their entireties.

### TECHNICAL FIELD

The present application relates to the technical field of infant carriers, and in particular, to a foldable carrier, a carrier frame of a child carrying device, and a child carrying device.

### BACKGROUND

A child carrying device can alleviate fatigue caused by holding a baby by hand for a long time, which improves comfort of people's lives. The child carrying devices currently available on the market, such as strollers, or child dining chairs, is generally foldable, and generally include a foldable carrier and a carrier frame. The foldable carrier can be folded along with the carrier frame, so that the overall occupied volume of the child carrying device can be reduced, such that the child carrying device can be stored and carried easily, and the user's convenience can be improved.

For example, the child carrying device generally includes a handle portion and a front leg portion. To store and carry the child carrying device conveniently when not in use, the handle portion and the front leg portion are generally foldable relative to each other, thereby reducing the occupied volume of the child carrying device.

In addition, the foldable carriers of some of the child carrying devices may be detached from carrier frame for easy storage. In a typical child carrying device in which a foldable carrier and a carrier frame are detachable, the carrier frame may be provided with a holder, and the foldable carrier of the child carrying device may be detachably engaged with the holder.

### SUMMARY

According to various embodiments of the present application, a foldable carrier, a carrier frame of a child carrying device, and a child carrying device are provided.

According to an aspect of the present application, a foldable carrier includes: a seat assembly; an armrest assembly pivotable relative to the seat assembly and movable between a folded position and an unfolded position, the armrest assembly being provided with a locking portion; a backrest assembly having a folded position and an unfolded position; a linkage assembly movably connected to the backrest assembly; and a locking member, one end of the locking member being pivotally connected to the linkage assembly, the other end of the locking member being capable of being fitted with the locking portion, the backrest assembly being folded in a direction approaching the armrest assembly to drive, through the linkage assembly, the locking member to be separated from the locking portion.

According to another aspect of the present application, a child carrying device includes a carrier frame and the foldable carrier as described above.

According to yet another aspect of the present application, a foldable carrier includes: a seat tube; seat bottom tubes; a backrest assembly pivotally connected to end portions of the seat bottom tubes; and a front cross rod arranged between the seat bottom tubes at an end away from the backrest assembly, wherein the foldable carrier further includes a folding locking mechanism. The folding locking mechanism is arranged between the seat bottom tubes and the front cross rod. When the folding locking mechanism is in a locked state, the seat tube and the seat bottom tubes are locked to an unfolded state. When the folding locking mechanism is in an unlocked state, the seat tube and the seat bottom tubes are pivotable relative to each other.

According to still another aspect of the present application, a child carrying device includes a foldable carrier, a carrier frame, and a holder configured for connecting the foldable carrier and the carrier frame. The foldable carrier includes: a first portion including a seat tube; and a second portion arranged below the first portion and including a backrest assembly, seat bottom tubes, a front cross rod, and a second folding mechanism. The backrest assembly is pivotally connected to one end of each of the seat bottom tubes. The front cross rod is arranged between the seat bottom tubes at an end away from the backrest assembly. The second folding mechanism is arranged on the backrest assembly and configured to adjust an inclination angle of the backrest assembly relative to each of the seat bottom tubes. The second portion further includes the folding locking mechanism of the foldable carrier as described above.

According to a further aspect of the present application, a carrier frame of a child carrying device is provided. A holder is mounted on the carrier frame. The holder is configured to be engaged with a foldable carrier of the child carrying device. The carrier frame has an unfolded state and a folded state, and the holder has an effective position corresponding to the unfolded state and an ineffective position corresponding to the folded state. When the carrier frame is switched between the unfolded state and the folded state, the carrier frame drives the holder to switch between the effective position and the ineffective position.

According to a further aspect of the present application, a child carrying device, including a foldable carrier and the carrier frame as described above.

### BRIEF DESCRIPTION OF THE DRAWINGS

FIG. 1 is a schematic perspective view of a child carrying device according to an embodiment of the present application.

FIG. 2 is a schematic perspective view of a foldable carrier in the child carrying device shown in FIG. 1, with the foldable carrier in an unfolded state.

FIG. 3 is a schematic perspective view of the foldable carrier shown in FIG. 2 from another perspective.

FIG. 4 is another schematic perspective view of the foldable carrier shown in FIG. 2, with the foldable carrier in a folded state.

FIG. 5 is a schematic perspective view of the foldable carrier shown in FIG. 2 from yet another perspective, in which case the foldable carrier is in the unfolded state.

FIG. 6 is an enlarged view of a portion A in FIG. 5.

FIG. 7 is yet another schematic perspective view of the foldable carrier shown in FIG. 2, with the foldable carrier in a partially folded state.

FIG. 8 is an enlarged view of a portion B in FIG. 7.

FIG. 9 is an exploded view of the foldable carrier of FIG. 5.

FIG. 10 is an enlarged view of a portion C in FIG. 9.

FIG. 11 is a partial enlarged view of the foldable carrier shown in FIG. 5, with a side cover and part of a side plate removed.

FIG. 12 is another partial enlarged view of the foldable carrier shown in FIG. 5, with the side cover and part of the side plate removed.

FIG. 13 is a schematic perspective view of the components shown in FIG. 11 from another perspective.

FIG. 14 is a side view of the foldable carrier shown in FIG. 2, with the foldable carrier is in the unfolded state.

FIG. 15 is an enlarged view of a portion D in FIG. 14.

FIG. 16 is another side view of the foldable carrier shown in FIG. 2, with the foldable carrier in an intermediate state during switching from the unfolded state to the folded state.

FIG. 17 is an enlarged view of a portion E in FIG. 16.

FIG. 18 is yet another side view of the foldable carrier shown in FIG. 2, with the foldable carrier in the folded state.

FIG. 19 is an enlarged view of a portion F in FIG. 18.

FIG. 20 is still another side view of the foldable carrier shown in FIG. 2, with the foldable carrier in an intermediate state during switching from the folded state to the unfolded state.

FIG. 21 is an enlarged view of a portion G in FIG. 20.

FIG. 22 is an exploded view of the foldable carrier of FIG. 11.

FIG. 23 is a partial cross-sectional view of the foldable carrier according to an embodiment of the present application, with an angle adjustment locking member in a first driving position.

FIG. 24 is an enlarged view of a portion H in FIG. 23.

FIG. 25 is a partial cross-sectional view of a backrest assembly in the foldable carrier shown in FIG. 23, with the angle adjustment locking member in a second driving position.

FIG. 26 is an enlarged view of a portion I in FIG. 25.

FIG. 27 is a schematic perspective view of an armrest assembly and a seat assembly in the foldable carrier shown in FIG. 23.

FIG. 28 is an exploded view of the backrest assembly shown in FIG. 25.

FIG. 29 is an enlarged view of J in FIG. 28.

FIG. 30 is a schematic diagram of a child carrying device according to another embodiment of the present application.

FIG. 31 is a schematic diagram of a foldable carrier of the child carrying device shown in FIG. 30.

FIG. 32 is a schematic diagram of a backrest assembly in the foldable carrier of the child carrying device shown in FIG. 30 at an inclination angle different from that in FIG. 31.

FIG. 33 is another schematic diagram of the foldable carrier of the child carrying device shown in FIG. 30 in a folded state.

FIG. 34 and FIG. 35 are schematic side views of the backrest assemblies in the child carrying devices shown in FIG. 30 at different inclination angles relative to seat bottom tubes.

FIG. 36 is a schematic diagram of a pose of the foldable carrier of the child carrying device shown in FIG. 30.

FIG. 37 and FIG. 38 are schematic diagrams of other two poses of the foldable carrier of the child carrying device shown in FIG. 30.

FIG. 39 is a schematic exploded view of a second folding mechanism of the child carrying device shown in FIG. 30.

FIG. 40 is another schematic enlarged exploded view of the second folding mechanism of the child carrying device shown in FIG. 30.

FIG. 41 is a schematic diagram of a folding locking mechanism of the child carrying device shown in FIG. 30 in a locked state.

FIG. 42 is a schematic diagram of the folding locking mechanism of the child carrying device shown in FIG. 30 in an unlocked state.

FIG. 43 is another perspective view schematically showing the child carrying device shown in FIG. 1.

FIG. 44 is a perspective view schematically showing a carrier frame of the child carrying device shown in FIG. 43, with the carrier frame in an unfolded state and a holder in an effective position.

FIG. 45 is a perspective view schematically showing a cross-section taken along a line A-A in FIG. 44.

FIG. 46 is a schematic diagram schematically showing connection relationships among a front leg frame, a handle frame, a support frame, and the holder shown in FIG. 45.

FIG. 47 is a perspective view schematically showing the carrier frame of the child carrying device shown in FIG. 43, with the carrier frame in a half-folded state.

FIG. 48 is a perspective view schematically showing a cross-section taken along a line E-E in FIG. 47.

FIG. 49 is a perspective view schematically showing a carrier frame shown in FIG. 43, with the carrier frame in a folded state and the holder in an ineffective position.

FIG. 50 is schematic diagram schematically showing connection relationships among a front leg frame, a handle frame, a support frame, and the holder shown in FIG. 49.

### ILLUSTRATIONS FOR REFERENCE SIGNS

10. foldable carrier, 20. carrier frame, 1. front leg frame, 2. handle frame, 25. connecting pin, 2100. threaded hole, 24. fourth engaging structure, 100. seat assembly, 110. seat body, 120. side plate, 121. first side guard, 1211. guide groove, 1212. first position, 1213. second position, 1214. locking hole, 1215. first pivot hole, 122. second side guard, 1221. cylindrical protrusion, 130. side cover, S100. first portion, S110. first folding mechanism, S120. seat tube, S130. seat tube upper portion, S140. seat tube lower portion, S150. pivot base, 20. carrier frame, 21. handle member, 22. underframe, 23. wheel, 200. armrest assembly, 210. armrest body, 220. armrest support rod, 221. locking portion, 221a. locking groove, 221b. bottom wall, 222. engagement hole, S200. second portion, S210. second folding mechanism, S211. control member, S212. adjustment member, S2121. backrest adjustment locking member, S2122. backrest adjustment locking gear, S213. pulling member, S214. reset member, S230. seat bottom tube, S241. front cross rod, S242. rear cross rod, S250. connecting portion, S251. recess, S270. support belt, S260. folding locking mechanism, S261. locking pin, S262. rotating member, S2621. protrusion, S263. driving member, S2631. driving member inner groove, S2632. protrusion, S264. fixing member, S2641. fixing member inner groove, S265. first elastic member, S266. second elastic member, S267. third elastic member, 300. backrest assembly, 310. backrest body, 320. backrest support assembly, 321. backrest support rod, 3211. first through hole, 322. fixing member, 3221. via hole, 323. adjustment locking member, 3222. second through hole, 330. angle adjustment mechanism, 331. angle adjustment locking member, 331a. guide protrusion, 331b. limiting circular portion, 332. operating assembly, 332a. operating handle, 332b. connecting member, 332c. pulling member, 333. driving assembly, 333a. rod member, 333b. driving post, 333c. rod reset member, 333d. driving slope, 334. mounting cover, 334a. mounting groove, 335m angle adjustment reset member, 3. support frame, 31. upper bracket, 3100. first cross arm, 3200. second cross arm, 32. lower bracket, 34. second engaging structure, 4. holder, 401. sliding hole, 4011. upper end, 4012. lower end, 402. cover plate, 403. accommodating portion, 4030. bottom opening, 41. first engaging structure, 43. third engaging structure, 400. linkage assembly, 410. driving member, 411. driving groove, 420. linkage member, 430. first reset member, 440. driving pin, 450. guide pin, 500. locking member, 500a. locking pin, 600. second reset member, 600a. tension spring, M. first pivot point, N. second pivot point, O. third pivot point, P. first circle, Q. second circle, 61. front wheel, 62. rear wheel, 71. pedal frame, 72. cross rod, 8. seat, 80. handle portion, 91. first pivot, 92. second pivot, 93. third pivot, 94. fourth pivot, 95. fifth pivot.

### DETAILED DESCRIPTION OF THE EMBODIMENTS

In order to make the above objects, technical solutions, and advantages of the present application more obvious and understandable, the present application is described in further detail below with reference to the accompanying drawings and specific embodiments. It should be understood that specific embodiments described herein are intended only to explain the present application, and are not intended to limit the protection scope of the present application.

It should be noted that when one element is referred to as “fixed to” another element, it may be directly disposed on the another element or an intermediate element may exist. When one element is considered to be “connected to” another element, it may be directly connected to the another element or an intermediate element may co-exist. The terms “vertical”, “horizontal”, “left”, “right” and similar expressions used herein are for illustrative purposes only, and are not meant to be unique embodiments.

Unless defined otherwise, all technical and scientific terms used herein have the same meanings as would generally understood by those skilled in the technical field to which the present application belongs to. The terms used herein in the specification of the present application are for the purpose of describing specific embodiments only, and are not intended to limit the present application. The term “and/or” used herein includes any and all combinations of one or more associated listed items.

In an embodiment of the present application, a foldable carrier is provided. The foldable carrier includes: a seat assembly; an armrest assembly connected to the seat assembly; and a backrest assembly having a folded position and an unfolded position and including a backrest body, and backrest support assemblies connected to two ends of the backrest body and an adjustment assembly. The adjustment assembly includes: an operating mechanism arranged on the backrest body; and a driving mechanism configured to adjust an inclination angle of the backrest assembly relative to the seat assembly. In the unfolded position, the operating mechanism is operable to drive the driving mechanism to enable the inclination angle of the backrest assembly relative to the seat assembly to be adjusted at multiple angles. For example, the operating mechanism is operable to drive the driving mechanism to enable the inclination angle of the backrest assembly relative to the seat assembly to be adjusted in four levels. In various embodiments of the present application, the adjustment assembly may be an angle adjustment mechanism or a second folding locking mechanism as described below. Specific details of a configuration of the adjustment assembly will be further described through the following embodiments.

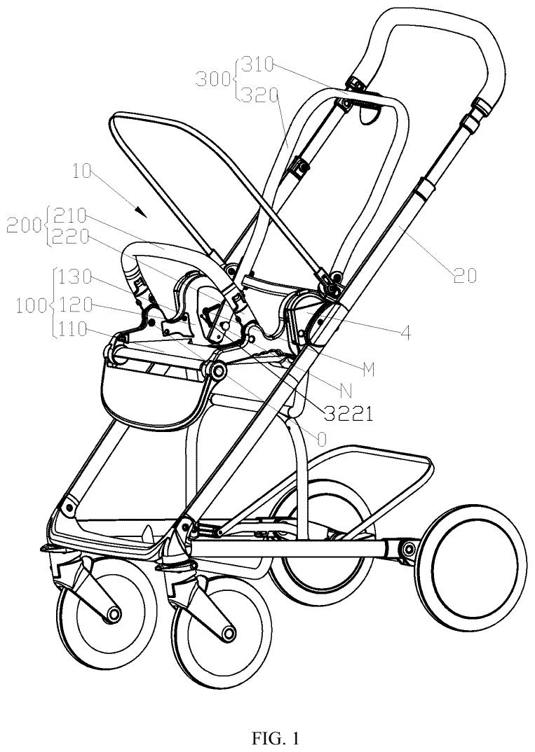

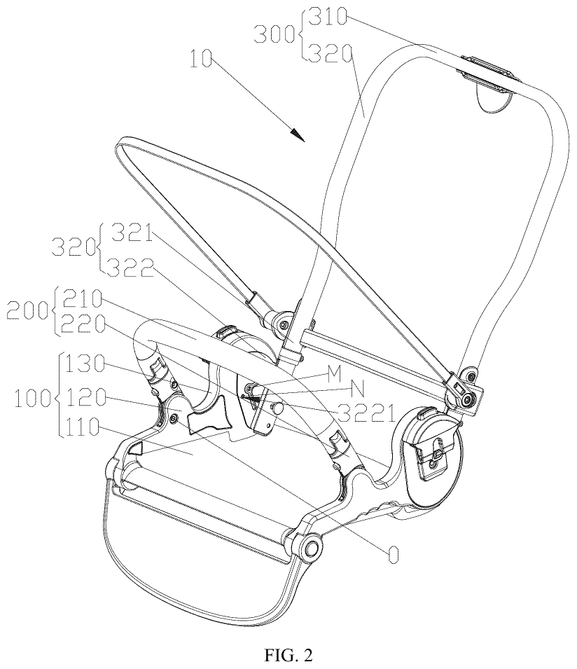

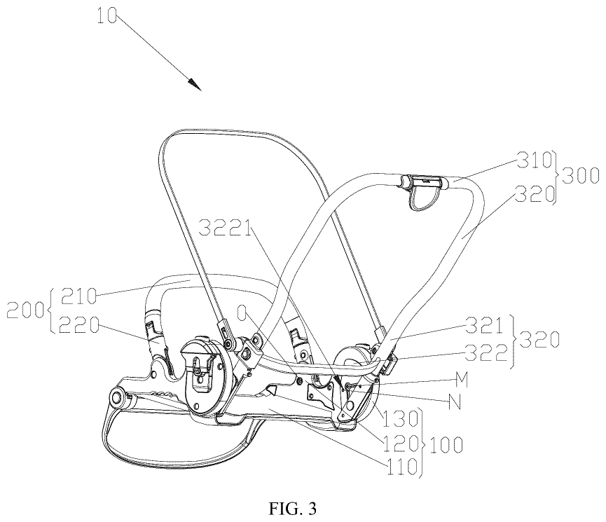

As shown in FIG. 1, an embodiment of the present application proposes a child carrying device. The child carrying device includes a foldable carrier 10 and a carrier frame 20. The foldable carrier 10 can be detachably or non-detachably mounted on the carrier frame 20. For example, the foldable carrier 10 may be detachably connected to the carrier frame 20 through a holder 4, as shown in FIG. 1. Herein, a description is based on an example in which the child carrying device is a stroller, but the type of the child carrying device is not limited to the stroller. The child carrying device of the present application may be understood in a broad sense, including, but not limited to, a full-featured stroller, a lightweight foldable stroller, a high-view stroller, an umbrella stroller, or the like. Certainly, in other embodiments, the child carrying device may alternatively be a bassinet, a car safety seat, a bouncing chair, a high chair, a child dining chair, or the like. The foldable carrier 10 and an armrest support rod 220 of the child carrying device can be folded along with a folding of a backrest support assembly 320, which is convenient to use.

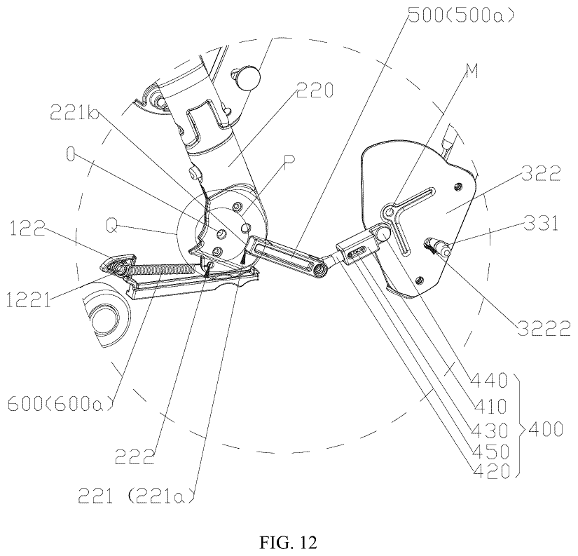

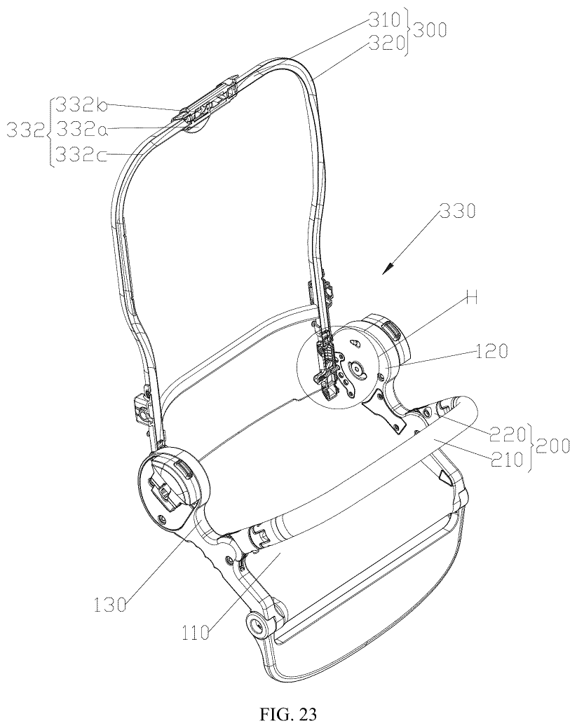

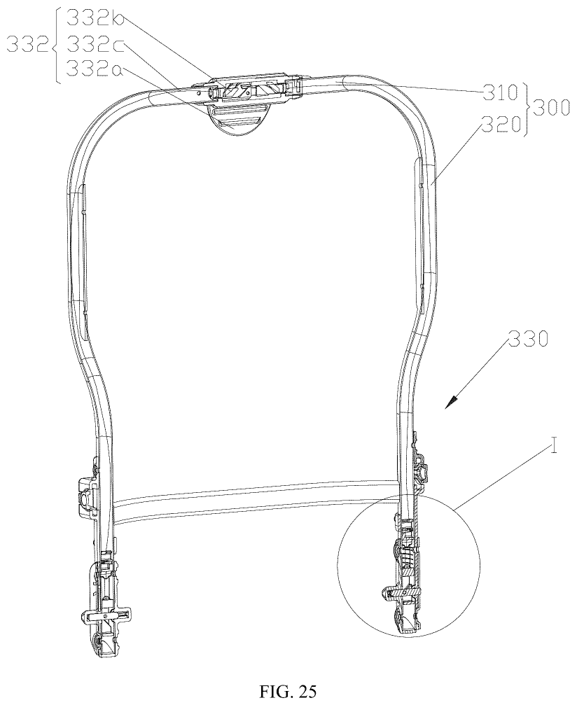

Specifically, as shown in FIGS. 1 and 12, the foldable carrier 10 includes a seat assembly 100, an armrest assembly 200, a backrest assembly 300, a linkage assembly 400, a locking member 500, and a second reset member 600. The seat assembly 100 includes a seat body 110, two side plates 120, and two side covers 130. The seat body 110 is configured to carry a child. The two side plates 120 are respectively connected to two opposite sides of the seat body 110, i.e., left and right sides of the seat body 110, and the two side plates 120 are opposite to each other. The two side covers 130 are also respectively arranged on the two opposite sides of the seat body 110, i.e., the left and right sides of the seat body 110, and are both arranged on sides of the side plates 120 facing away from the seat body 110, i.e., an outer side surface of the seat body 110. On each of the sides of the seat body 110, the side plate 120 and the side cover 130 encloses an accommodating space. The armrest assembly 200 includes an armrest body 210 and an armrest support rod 220 connected to two ends of the armrest body 210. The backrest assembly 300 includes a backrest body 310 and backrest support assemblies 320 connected to two ends of the backrest body 310. The backrest assembly 300 further includes an angle adjustment mechanism 330 (as shown in FIGS. 23 and 25) as the above adjustment assembly. The two ends of the armrest body 210 are detachably connected to the armrest support rod 220 arranged on the two sides of the seat body 110, so as to facilitate the child to be seated. The two ends of the backrest body 310 are respectively connected to the backrest support assemblies 320 arranged on the two sides of the seat body 110. The angle adjustment mechanism 330 is configured to adjust an inclination angle of the backrest support assemblies 320 on the two sides relative to the seat assembly 100, to provide the child with comfortable seated (lying) angles as required. The left and right sides of the seat body 110 are each provided with the armrest support rod 220, the backrest support assembly 320, the linkage assembly 400, the locking member 500, and the second reset member 600. Moreover, on each of the sides of the seat body 110, both the linkage assembly 400 and the locking member 500 are arranged in the accommodating space.

A configuration of the foldable carrier 10 is specifically described below by taking the side plate 120, the side cover 130, the armrest support rod 220, the backrest support assembly 320, the angle adjustment mechanism 330, the linkage assembly 400, the locking member 500, and the second reset member 600 arranged on one side of the seat body 110 as an example.

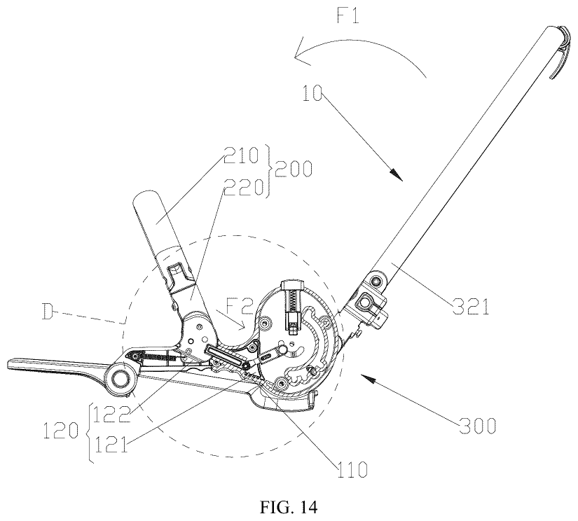

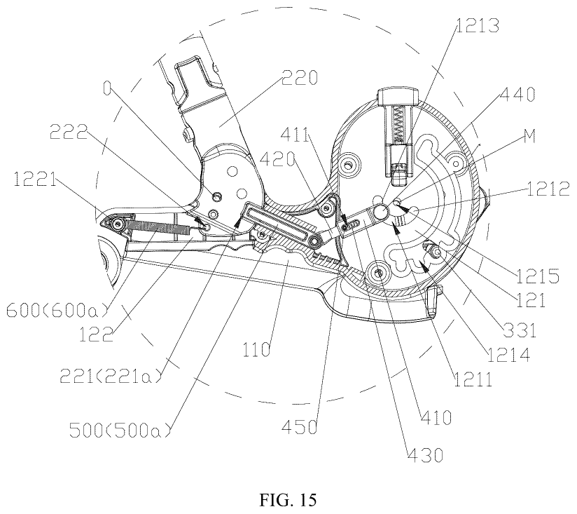

Specifically, in this embodiment, as shown in FIGS. 14 and 15, the side plate 120 includes a first side guard 121 on a rear side and a second side guard 122 on a front side. The first side guard 121 and the second side guard 122 are connected to each other. In this embodiment, the seat body 110 is integrally formed with two first side guards 121 and two second side guards 122. Certainly, in other embodiments, the seat body 110, the two first side guards 121, and the two second side guards 122 may alternatively be independent of each other. The first side guard 121 includes a first pivot hole 1215. An inner side of the first side guard 121 further includes a guide groove 1211. The guide groove 1211 is an arc groove bent around the first pivot hole 1215. A plurality of locking holes 1214 are further provided at lower positions of the first side guard 121.

Specifically, as shown in FIGS. 14 and 15, the armrest support rod 220 is pivotally connected to the second side guard 122 at a third pivot point O, and a locking portion 221 is arranged on a rear side of the armrest support rod 220, i.e., a side close to a backrest support rod 321. In this embodiment, the locking portion 221 is a locking groove 221a. As shown in FIG. 12, a first circle P and a second circle Q with different radii are drawn with the third pivot point O as a center, and the radius of the second circle Q is greater than the radius of the first circle P. The first circle P is tangent to a bottom wall 221b of the locking groove 221a, and the second circle Q is tangent to a notch of the locking groove 221a. That is, the locking groove 221a extends along a radial direction of the first circle P. In this way, the locking pin 500a (described in detail later) is inserted into the locking groove 221a in the radial direction of the first circle P (or the second circle Q). When the armrest support rod 220 is pressed, a direction of the force applied to the armrest support rod 220 is parallel to a tangential direction of the second circle Q passing through the locking pin 500a. The tangential direction is perpendicular to a longitudinal direction of the locking pin 500a. In this way, the locking pin 500a neither is easily crushed, nor may be casually or easily separated, which can better hold the armrest support rod 220 in an unfolded position. in addition, the armrest support rod can be folded only after the locking pin 500a is completely separated from the locking groove 221a. In this way, the armrest support rod 220 can also be folded more smoothly.

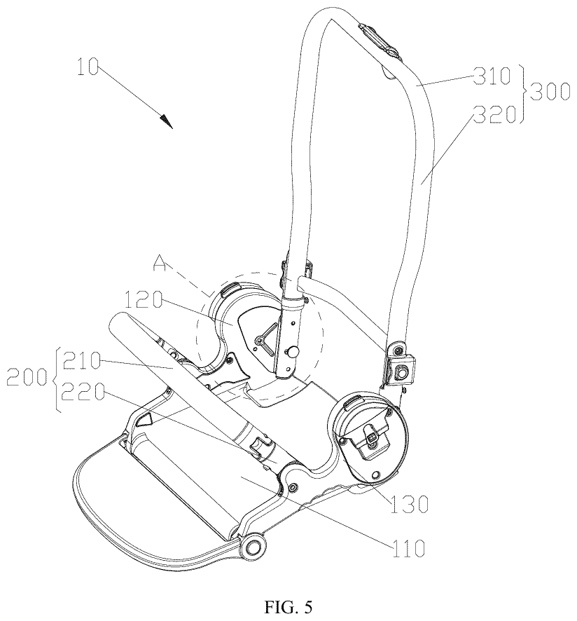

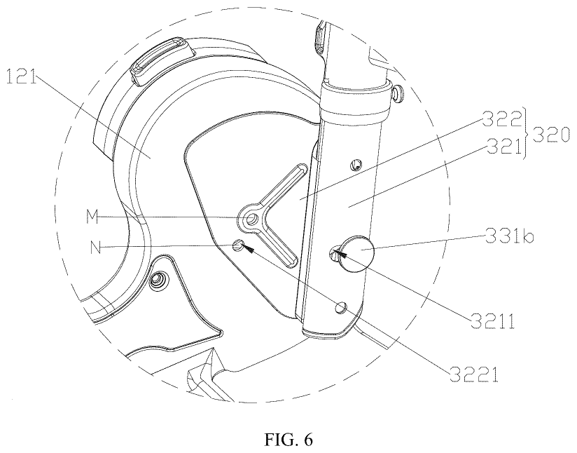

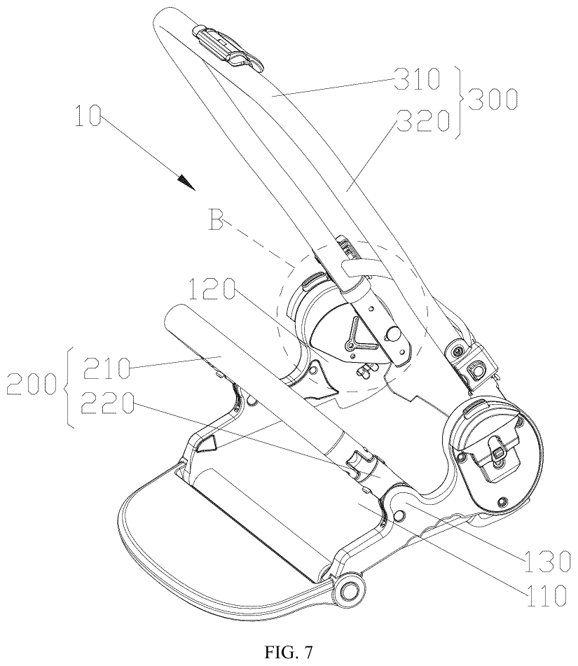

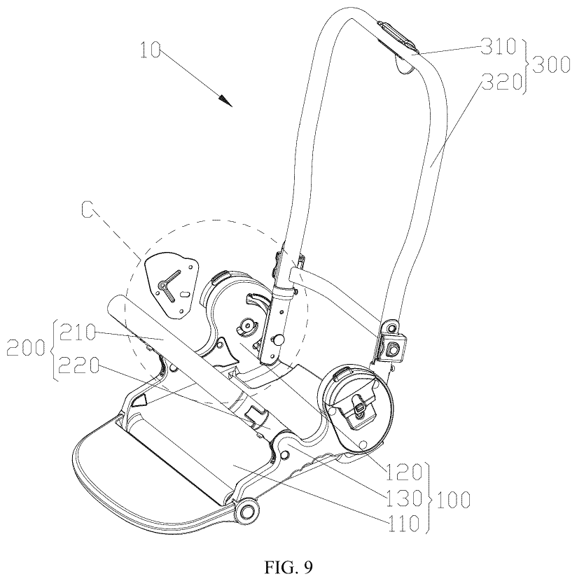

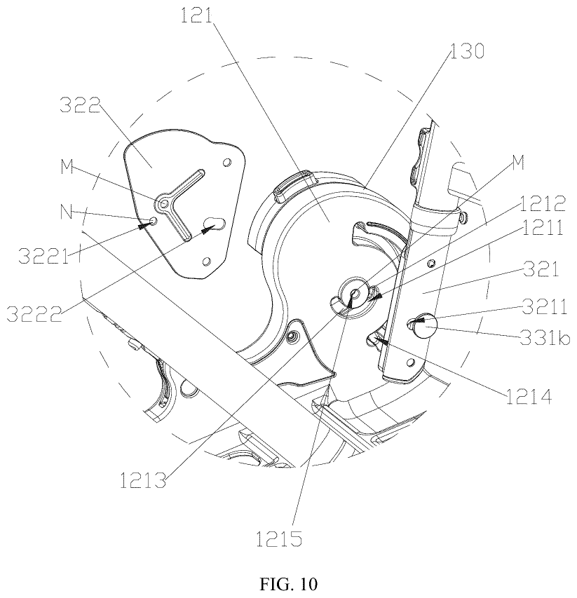

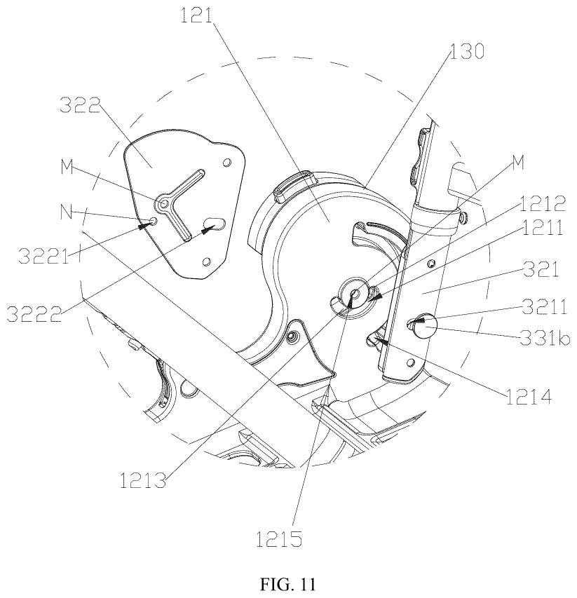

Specifically, as shown in FIGS. 5 to 10, the backrest support assembly 320 includes a backrest support rod 321 and a fixing member 322. The backrest support rod 321 includes a first through hole 3211 (see FIG. 6). The backrest support rod 321 and the fixing member 322 are fixedly connected. Specifically, the fixing member 322 generally has a fan-shaped sheet structure, a radial side of the fixing member 322 is fixedly connected to the backrest support rod 321, and an approximate geometric middle portion of the fixing member 322 is pivotally connected to the first side guard 121 at a first pivot point M. Specifically, the fixing member 322 is pivotally connected to the first side guard 121 at the first pivot hole 1215 (see FIG. 10) through a pivot shaft (not shown in the figure). That is, the first pivot point M is arranged at a center of the first pivot hole 1215. The fixing member 322 is provided with a via hole 3221. The via hole 3221 is offset from the first pivot point M. A center of the via hole 3221 is arranged at a second pivot point N. The fixing member 322 is further provided with a second through hole 3222 for an angle adjustment locking member 331 (described in detail later) of the angle adjustment mechanism 330 to extend through (for example, see FIG. 11). In this embodiment, the second through hole 3222 is an elongated hole. Certainly, in another embodiment, the second through hole 3222 may alternatively be a round hole.

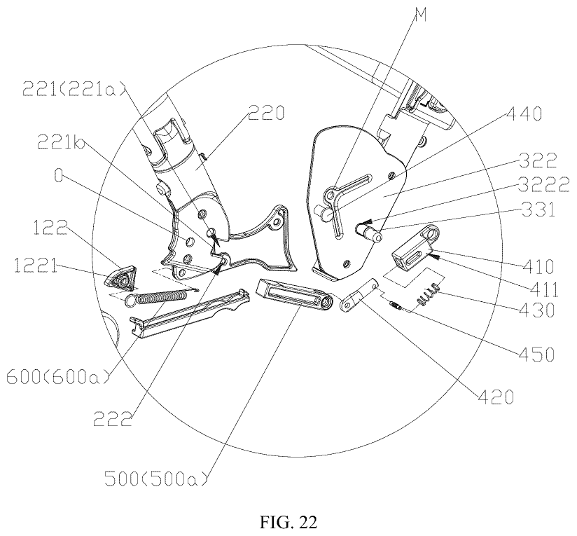

The backrest assembly 300 has a folded position and an unfolded position. Specifically, as shown in FIGS. 22 to 26, the angle adjustment mechanism 330 includes an operating assembly 332 as the above operating mechanism, and a driving assembly 333 as the above driving mechanism. The angle adjustment mechanism 330 further includes an angle adjustment locking member 331, a mounting cover 334, and an angle adjustment reset member 335. One end of the angle adjustment locking member 331 is arranged on a side of the backrest support rod 321 facing the seat body 110, that is, an inner side of the seat body 110. During folding or unfolding of the backrest support assembly 320, the other end of the angle adjustment locking member 331 extends through the first through hole 3211 of the backrest support rod 321 and the second through hole 3222 of the fixing member 322, and is fitted and locked into any one of the locking holes 1214 of the first side guard 121 at different positions, so that the backrest support assembly 320 is fixed at different angles relative to the seat assembly 100. Specifically, due to different requirements for the angle of the backrest support assembly 320 relative to the seat assembly 100, an adjustment locking member 323 may extend through the first through hole 3211 and the second through hole 3222, and be inserted into any one of the locking holes 1214 of the first side guard 121. Specifically, the angle adjustment locking member 331 has a first driving position and a second driving position. When the angle adjustment locking member 331 is in the first driving position, the angle adjustment locking member 331 is inserted into one of the locking holes 1214. That is, the backrest assembly 300 is fixed at a certain inclination angle relative to the seat body 110. When the angle adjustment locking member 331 is in the second driving position, the angle adjustment locking member 331 is withdrawn from the locking hole 1214. In this case, the inclination angle of the backrest assembly 300 relative to the seat body 110 can be adjusted.

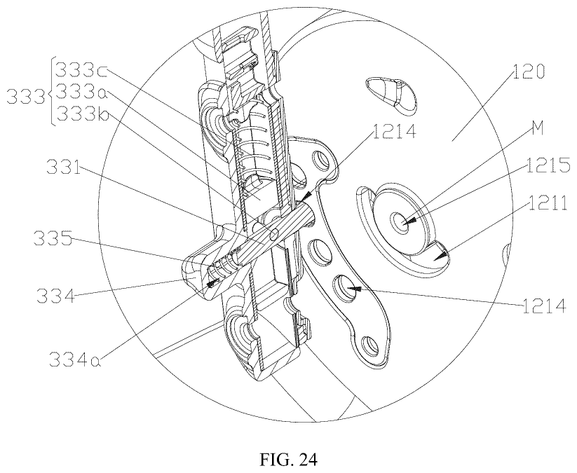

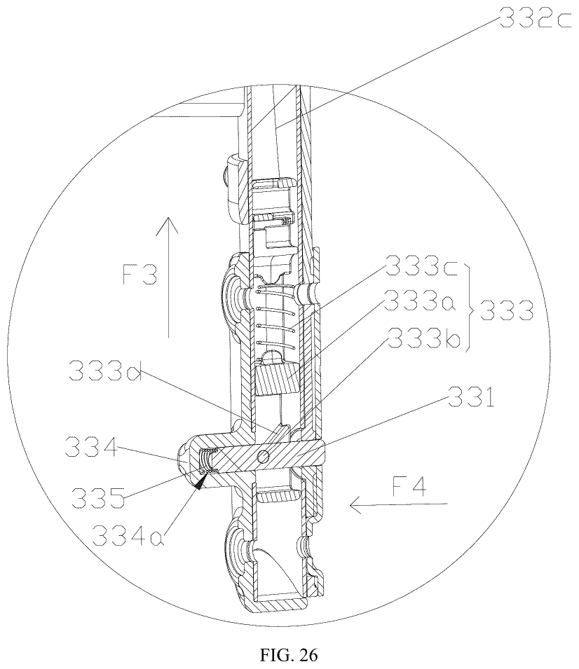

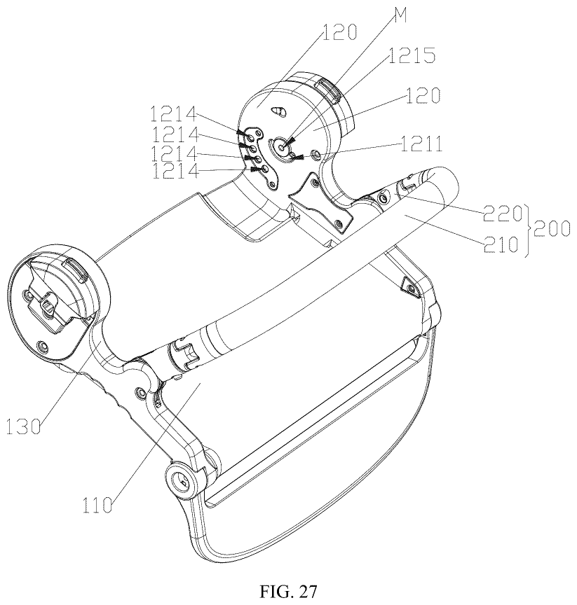

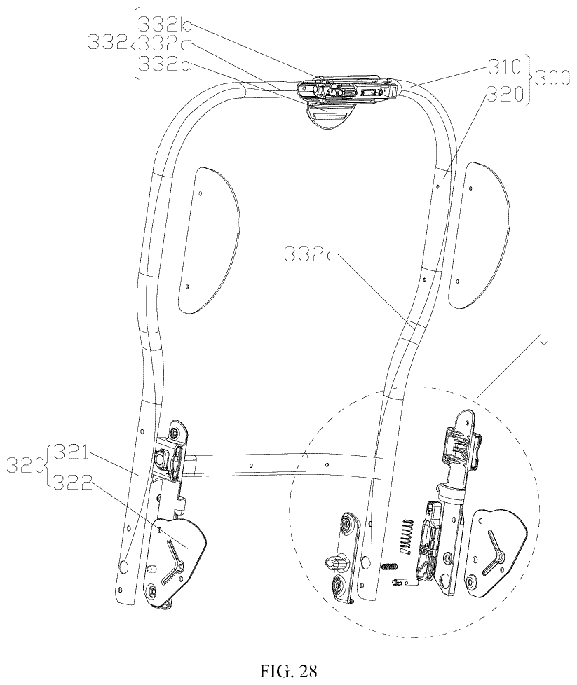

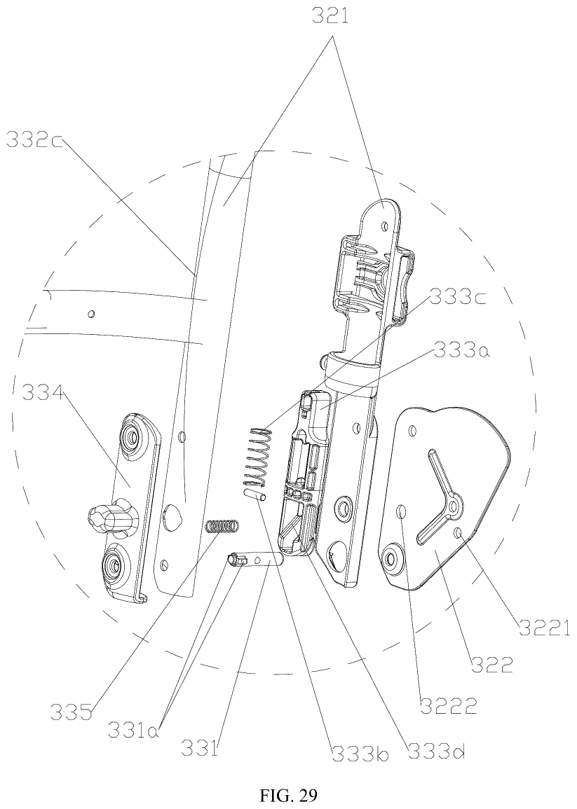

In this embodiment, as shown in FIG. 11, an end of the angle adjustment locking member 331 adjacent to the seat body 110 may be provided with a limiting circular portion 331b. A diameter of the limiting circular portion 331b is greater than a hole diameter of the first through hole 3211. In this way, the angle adjustment locking member 331 can be prevented from being separated from the backrest support assembly 320. Certainly, in another embodiment, as shown in FIG. 24, a mounting cover 334 may alternatively be provided. The mounting cover 334 is attached to or formed on a side of the backrest support rod 321 facing the seat body 110. A side of the mounting cover 334 facing the backrest support rod 321 is provided with a mounting groove 334a arranged opposite to and communicated with the first through hole 3211. One end of the angle adjustment locking member 331 is movably arranged in the mounting groove 334a. Specifically, as shown in FIGS. 28 and 29, two guide protrusions 331a may be symmetrically arranged on a sidewall of the angle adjustment locking member 331. The mounting groove 334a has a cross-sectional shape matching that of the angle adjustment locking member 331. That is, when one end of the angle adjustment locking member 331 is movably arranged in the mounting groove 334a, the two guide protrusions 331a cooperate with a sidewall of the mounting groove 334a. In this way, the movement of the angle adjustment locking member 331 in the mounting groove 334a may be guided, so that the angle adjustment locking member 331 can slide more smoothly in the mounting groove 334a. Further, two ends of the angle adjustment reset member 335 abut against a bottom wall of the mounting groove 334a and the angle adjustment locking member 331 (specifically, the two guide protrusions 331a) respectively, and the angle adjustment reset member 335 constantly enables the angle adjustment locking member 331 to move in a direction approaching the first side guard 121 (i.e., a direction opposite to a direction indicated by F4 in FIG. 26). In this embodiment, the angle adjustment reset member 335 is a spring.

When the backrest assembly 300 is in the unfolded position, the operating assembly 332 is operable to drive the driving assembly 333 to enable the inclination angle of the backrest assembly 300 relative to the seat assembly 100 to be adjusted at multiple angles. Specifically, as shown in FIGS. 23 and 25, the operating assembly 332 includes an operating handle 332a, two pulling reset members (not shown in the figures), two connecting members 332b, and a pulling member 332c. The operating handle 332a is rotatably arranged on the backrest body 310. The two connecting members 332b are respectively configured to connect ends of two pulling members 332c arranged on two sides of the backrest body 310 respectively. The other ends of the two pulling members 332c are respectively connected to rod members 333a (described in detail later) of the angle adjustment mechanism 330 arranged on the two sides of the seat body 110. In this embodiment, the pulling member 332c is a steel wire. The two connecting members 332b are movable and spaced apart on the backrest body 310. In this embodiment, the two pulling reset members are both torsion springs, and are respectively connected between the two connecting members 332b and the operating handle 332a. Taking the torsion spring and the connecting member 332b on one side as an example, the torsion spring is sleeved on a rotating shaft of the operating handle 332a, and two ends of the torsion spring are respectively connected to the operating handle 332a and the connecting member 332b. When a user presses the operating handle 332a, the operating handle 332a can be rotated around the backrest body 310 and drive, through the torsion spring, the connecting member 332b to move, so that the connecting member 332b pulls the pulling member 332c upward. When the user does not press the operating handle 332a, the operating handle 332a may be reset under the action of the torsion spring, and drive the connecting member 332b to be reset.

Specifically, as shown in FIGS. 24 and 26, the driving assembly 333 includes a rod member 333a, a driving post 333b, and a rod reset member 333c. The rod member 333a is movably arranged in the backrest support rod 321 and extends in a length direction of the backrest support rod 321. One end of the rod member 333a is connected to an end of the pulling member 332c away from the connecting member 332b, and a roughly middle portion of the rod member 333a includes a driving slope 333d. The rod reset member 333c is embedded in a middle and upper portion of the rod member 333a. Two ends of the rod reset member 333c abut against the rod member 333a and the backrest support rod 321 respectively. The rod reset member 333c constantly enables the rod member 333a to move in a direction (i.e., a direction opposite to F3 in FIG. 26) opposite to a direction in which the pulling member 332c is pulled. When the user does not press the operating handle 332a, the rod member 333a can be reset under the action of the rod reset member 333c. In this embodiment, the rod reset member 333c is a spring. The driving post 333b is fixed to a roughly middle portion of the angle adjustment locking member 331. In this embodiment, the driving post 333b is arranged to be perpendicular to the angle adjustment locking member 331. Certainly, in other embodiments, an angle formed between the driving post 333b and the angle adjustment locking member 331 may be greater than 90 degrees or less than 90 degrees. The driving post 333b abuts against the driving slope 333d.

When the user pulls the pulling member 332c through the operating handle 332a, the pulling member 332c pulls the rod member 333a to move in the direction F3. In this case, driven by the driving slope 333d, the driving post 333b drives the angle adjustment locking member 331 to move in the direction F4 from the first driving position to the second driving position, so that the angle adjustment locking member 331 is released from one of the locking holes 1214. In this case, the backrest body 310 or the backrest support rod 321 can be moved to adjust the inclination angle of the backrest assembly 300 relative to the seat body 110. After the user adjusts the angle of the backrest assembly 300 relative to the seat body 110, the operating handle 332a may be released, the operating handle 332a is reset under the action of the pulling reset member, and the connecting member 332b is driven to be reset at the same time, and the connecting member 332b does not pull the pulling member 332c in the direction F3. The rod member 333a, to which the pulling member 332c applies no force, moves in a direction opposite to the direction F3 under the action of the rod reset member 333c. In this case, the driving post 333b drives the angle adjustment locking member 331 to move in the direction opposite to the direction F4 under the action of the driving slope 333d, and is inserted into another locking hole 1214 under an elastic force of the angle adjustment reset member 335, so that the backrest assembly 300 is fixed at another inclination angle relative to the seat body 110. In this way, the angle of the backrest assembly 300 relative to the seat body 110 is adjusted.

Certainly, the operating assembly 332 and the driving assembly 333 in this embodiment are for reference only. In other embodiments, the operating assembly 332 and the driving assembly 333 may alternatively be in other forms.

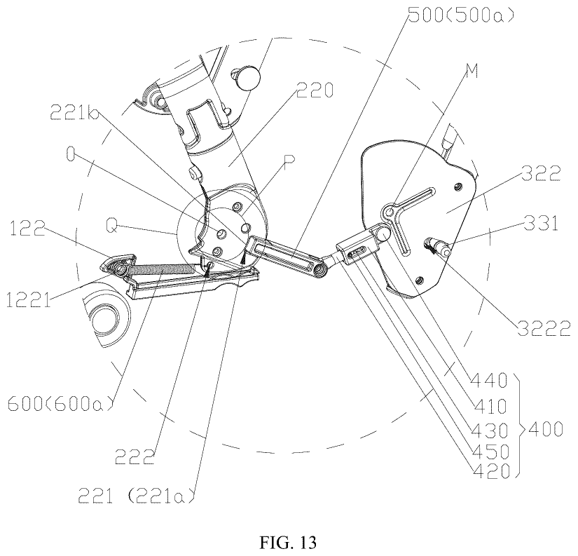

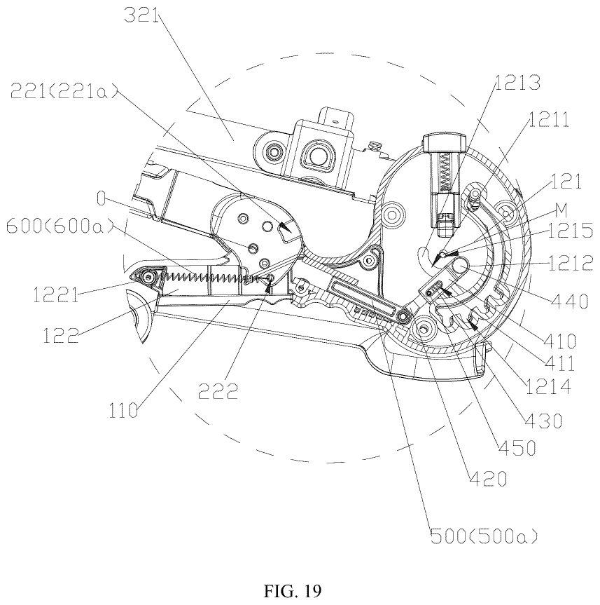

Specifically, as shown in FIGS. 11 to 13, the linkage assembly 400 includes a driving member 410, a linkage member 420, a first reset member 430, a driving pin 440, and a guide pin 450. The driving pin 440 is fixed to one end of the driving member 410. In this embodiment, the driving pin 440 and the driving member 410 are integrally formed. Certainly, in other embodiments, the driving pin 440 and the driving member 410 may alternatively be two separate components. An end of the driving pin 440 away from the driving member 410 is pivotally connected to the fixing member 322 at the second pivot point N (see FIG. 10). Specifically, the driving pin 440 extends through the guide groove 1211 of the first side guard 121, and is inserted into the via hole 3221 of the fixing member 322, and the driving pin 440 may slide along the guide groove 1211 (see FIGS. 11 and 15). In this embodiment, as shown in FIGS. 14 to 21, the guide groove 1211 is an arc groove bent around the first pivot point M. The guide groove 1211 has a first position 1212 and a second position 1213. As shown in FIG. 19, when the backrest support rod 321 is in the folded position, the driving pin 440 is in the first position 1212. As shown in FIG. 15, when the backrest support rod 321 is in the unfolded position, the driving pin 440 is in the second position 1213. Further, a first limiting member (not shown in the figure) may be sleeved on an end of the driving pin 440 away from the driving member 410. The first limiting member is arranged on a side of the fixing member 322 away from the first side guard 121. The first limiting member can prevent the driving pin 440 from being separated from the via hole 3221. Optionally, the first limiting member may be a ring clamp, a knurled rivet, a nut, or the like.

As shown in FIGS. 15 and 22, the driving member 410 is provided with a driving groove 411 arranged in a length direction thereof. The linkage member 420 roughly has a long rod structure. One end of the linkage member 420 is pivotally connected to the locking member 500, and the other end of the linkage member 420 is slidably connected to an end of the driving member 410 away from the driving pin 440. Specifically, the guide pin 450 is inserted into and fixed to the other end of the linkage member 420. For example, the guide pin 450 may be perpendicularly fixed to the linkage member 420, and the guide pin 450 is inserted into the driving groove 411 and is movable along the driving groove 411. The first reset member 430 is arranged in the driving groove 411. Two ends of the first reset member 430 abut against the guide pin 450 and an inner wall of the driving groove 411 respectively. The first reset member 430 constantly enables the linkage member 420 to move in a direction away from the driving pin 440.

In this embodiment, as shown in FIG. 15, the locking member 500 may be a locking pin 500a. One end of the locking pin 500a is pivotally connected to the linkage member 420, and the other end of the locking pin 500a can be inserted and fitted into the locking groove 221a to lock the armrest support rod 220 in an unfolded position. Two ends of the second reset member 600 are respectively connected to the second side guard 122 and the armrest support rod 220. The second reset member 600 constantly enables the armrest support rod 220 to rotate toward the unfolded position. In this embodiment, the second reset member 600 may be a tension spring 600a. Specifically, a cylindrical protrusion 1221 may be arranged on the second side guard 122, and an engagement hole 222 offset from the third pivot point O may be arranged on the armrest support rod 220. One end of the tension spring 600a is sleeved on the cylindrical protrusion 1221, and the other end of the tension spring 600a is hooked into the engagement hole 222. Certainly, the second reset member 600 may be mounted in other ways, and which is not limited thereto. For example, both the second side guard 122 and the armrest support rod 220 may be provided with the cylindrical protrusions 1221, or the engagement holes 222, etc.

Certainly, in other embodiments, the locking portion 221 is not limited to be the locking groove 221a, and the locking member 500 is not limited to be the locking pin 500a. For example, alternatively, the locking portion 221 may be a protrusion arranged on the armrest support rod 220, the locking member 500 may be provided with a recess matching the locking protrusion, etc., provided that the locking portion 221 and the locking member 500 can fit with each other or separated from each other to realize locking and releasing of the armrest support rod 220.

An operating principle of the above foldable carrier 10 is specifically as follows.

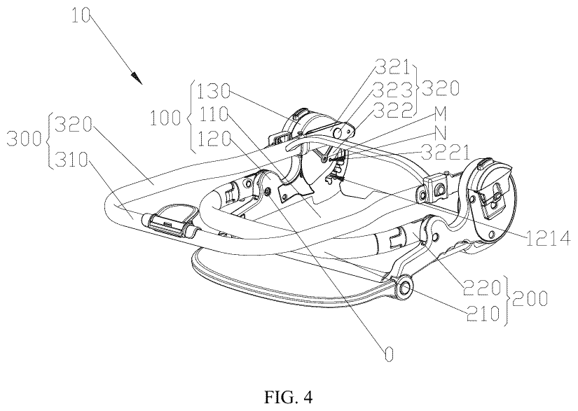

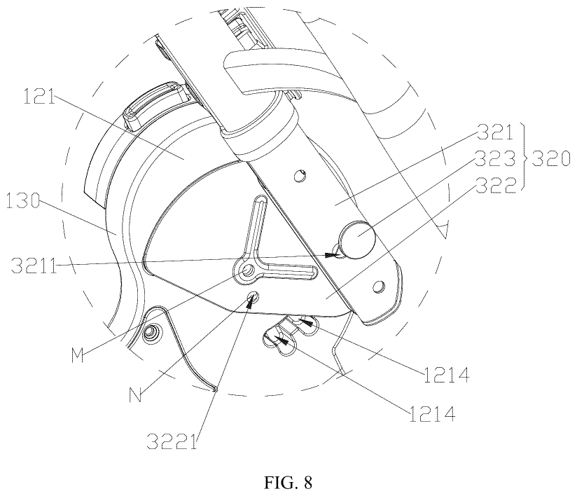

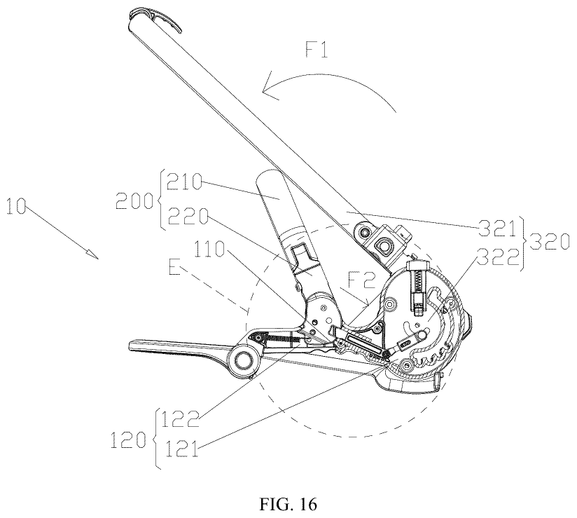

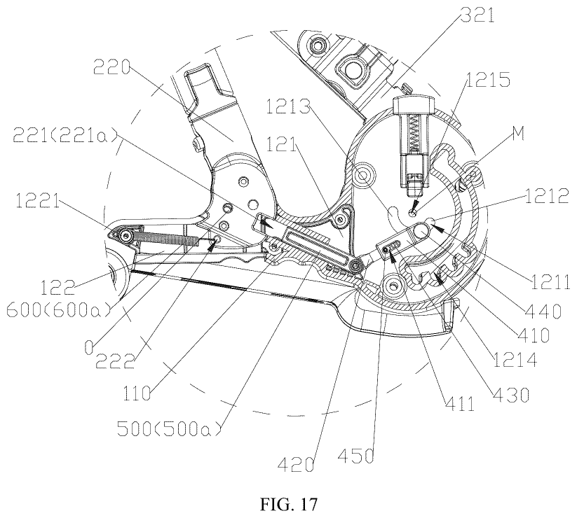

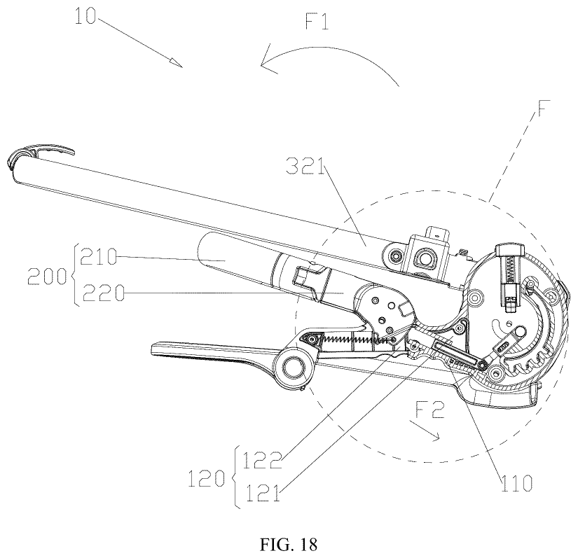

When it is required to fold the foldable carrier 10 in an unfolded state, as shown in FIGS. 14 and 15, the backrest assembly 300 is rotated in a direction approaching the armrest assembly 200, that is, the backrest support rod 321 drives the fixing member 322 (as denoted in FIG. 8) to rotate in the direction F1 as shown in FIG. 14, so that the fixing member 322 drives the driving pin 440 to slide from the second position 1213 to the first position 1212 along the guide groove 1211 (see FIGS. 16 to 19). In this case, the driving member 410 drives, through the linkage member 420, the locking pin 500a to move in the direction F2 as shown in FIG. 14 or FIG. 16 until the locking pin 500a is separated from the locking groove 221a, so that the armrest support rod 220 is released and can be pivoted relative to the seat assembly 100. In this case, the first reset member 430 is compressed. At the same time, as shown in FIGS. 16 and 17, the backrest support rod 321 rotating in the direction F1 may apply a force in the direction F1 to the armrest body 210, so that the armrest assembly 200 is also rotated to the folded position in the direction F1 accordingly, thereby realizing overall folding of the foldable carrier 10, as shown in FIGS. 18 and 19. In this case, the second reset member 600 is stretched. As shown in FIGS. 4, 18, and 19, when the backrest assembly 300 is in the folded position, the seat assembly 100, the armrest assembly 200, and the backrest assembly 300 are superposed on one another, and the armrest assembly 200 is arranged between the seat assembly and the backrest assembly 300.

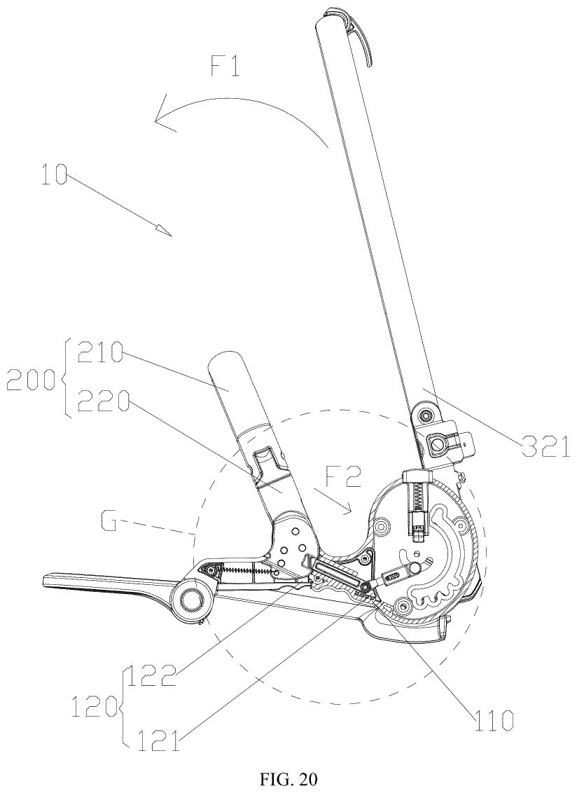

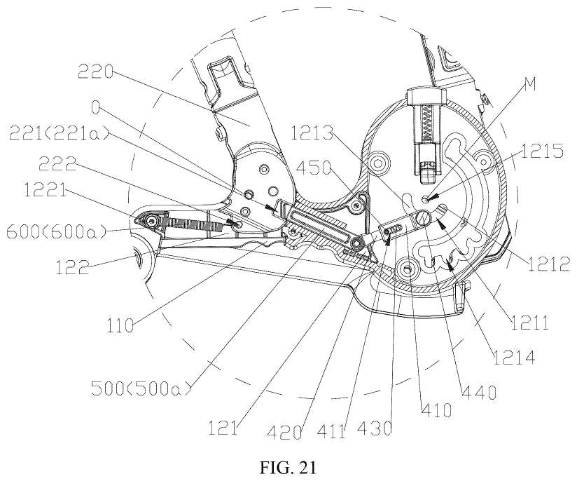

When it is required to unfold the foldable carrier 10 in a folded state, as shown FIGS. 18 and 19, the backrest assembly 300 is rotated in a direction away from the armrest assembly 200. As shown in FIGS. 20 and 21, the armrest assembly 200 to which the backrest support rod 321 applies no force is reset to the unfolded position in the direction opposite to the direction F1 under the action of the second reset member 600. In this case, the backrest support rod 321 drives the fixing member 322 to rotate in the direction opposite to the direction F1 as shown in FIG. 20, so that the fixing member 322 drives the driving pin 440 to slide from the first position 1212 to the second position 1213 along the guide groove 1211, and at the same time, the first reset member 430 pushes the locking pin 500a to be reset. In this way, under the combined action of the driving pin 440 and the first reset member 430, the locking pin 500a is just moved in the direction opposite to the direction F2 into the locking groove 221a formed in the armrest support rod 220, thereby locking the armrest support rod 220 in the unfolded position, as shown in FIGS. 14 and 15. Since the driving member 410, the linkage member 420, the guide groove 1211, and the first reset member 430 can cooperate with each other, the locking pin 500a can be moved more smoothly to be inserted and fitted into or separated from the locking groove 221a during the unfolding and the folding of the foldable carrier 10.

The above foldable carrier 10 and the child carrying device including the foldable carrier 10 have at least the following technical features.

In the above foldable carrier 10 and the child carrying device including the foldable carrier 10, the armrest support rod 220 may be pivoted relative to the seat assembly 100, and is thus moved between the folded position and the unfolded position, and the backrest support rod 321 also has the folded position and the unfolded position. When the foldable carrier 10 is unfolded, the locking member 500 is fitted and locked with the locking portion 221, so as to lock the armrest support rod 220 in the unfolded position. When it is required to fold the foldable carrier 10, only the backrest assembly 300 is required to be folded in the direction approaching the armrest support rod 220, and the locking member 500 pivotally connected to the linkage assembly 400 can be driven, through the linkage assembly 400, to be separated from the locking portion 221, thereby releasing the armrest support rod 220, so that the backrest support assembly 320 can press against the armrest support rod 220 to achieve a linked folding. In this way, the foldable carrier 10 realizes the linked folding of the armrest support rod 220 along with the backrest support assembly 320 through a simple structure. That is, the foldable carrier 10 and an armrest of the child carrying device can be folded together with the backrest, which is convenient to use.

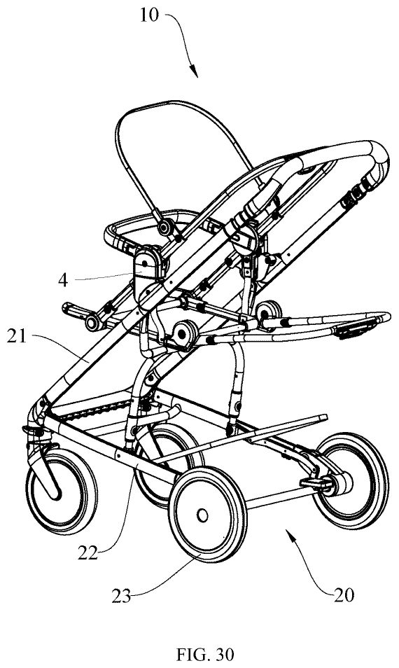

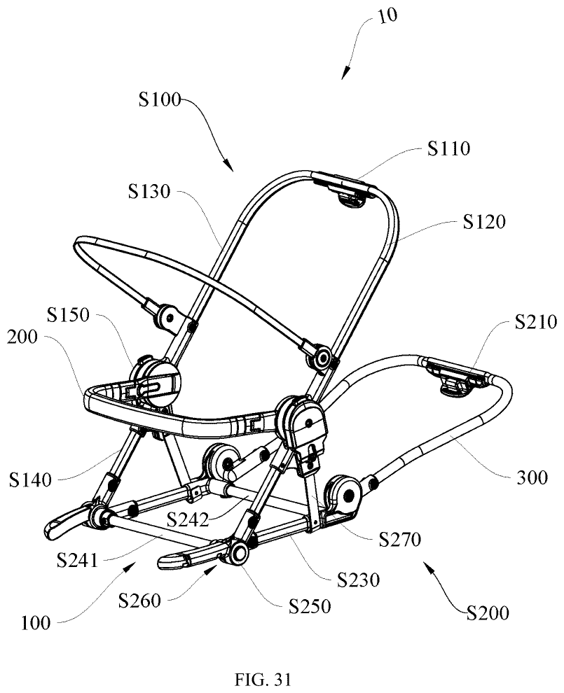

The foldable carrier 10 and the carrier frame 20 of the child carrying device may be connected to each other through a holder 4. FIGS. 30 and 31 schematically show a configuration of a foldable carrier 10 of a child carrying device according to another embodiment of the present application. As shown in FIG. 30, the foldable carrier 10 is entirely arranged above the carrier frame 20, which increases a height of the foldable carrier 10. The carrier frame 20 generally includes a handle member 21, an underframe 22, and wheels 23. The handle member 21 extends obliquely upward and backward from the wheels 23, so as to facilitate an operator to push a stroller 1 by pushing the handle member 21. Two holders 4 may be provided. The two holders 4 are arranged to be bilaterally symmetrical with respect to the entire child carrying device.

As shown in FIG. 31, the foldable carrier 10 of the present application may include a seat assembly 100; an armrest assembly 200 connected to the seat assembly 100; and a backrest assembly 300 having a folded position and an unfolded position. The seat assembly 100 may include: a seat tube S120; seat bottom tubes S230; a front cross rod S241 arranged between the seat bottom tubes S230 at an end away from the backrest assembly 300; and folding locking mechanisms S260 arranged between the seat bottom tubes S230 and the front cross rod S241. When the folding locking mechanism S260 is in a locked state, the seat tube S120 and the seat bottom tubes S230 are locked in an unfolded state. When the folding locking mechanism S260 is in an unlocked state, the seat tube S120 and the seat bottom tubes S230 are pivotable relative to each other. The backrest assembly 300 is pivotally connected to one end of the seat bottom tube S230. In addition, the seat assembly 100 may further include a rear cross rod S242. The rear cross rod S242 is arranged between the two seat bottom tubes S230 at an end adjacent to the backrest assembly 300.

In addition, from a spatial point of view, the foldable carrier 10 of the present application as a whole is roughly divided into two parts, namely, a first portion S100 arranged above and a second portion S200 arranged below. As shown in FIG. 31, the first portion S100 generally includes the armrest assembly 200, the seat tube S120, and a first folding mechanism S110. The seat tube is divided into a seat tube upper portion S130 and a seat tube lower portion S140. The seat tube upper portion S130 is connected to the seat tube lower portion S140 through a pivot base S150. The first folding mechanism S110 may be arranged on the seat tube $120, so as to facilitate an operation. The seat tube upper portion S130 and the seat tube lower portion S140 are pivotally connected to each other through the pivot base S150. Therefore, the seat tube upper portion S130 and the seat tube lower portion S140 can be folded relative to each other through the first folding mechanism S110.

As shown in FIG. 31, the second portion S200 generally includes: the backrest assembly 300; the seat bottom tubes S230 (in the embodiment shown in the figure, two seat bottom tubes S230 are provided, and the two seat bottom tubes S230 are arranged parallel to each other); the front cross rod S241 arranged between the two seat bottom tubes S230 at the end away from the backrest assembly 300; the rear cross rod S242 arranged between the two seat bottom tubes S230 at the end adjacent to the backrest assembly 300; and a connecting portion S250. The front cross rod S241 is pivotally connected to the seat bottom tube S230 through the connecting portion S250. The backrest assembly 300 is pivotally connected to one end of the seat bottom tube S230. Specifically, the backrest assembly 300 is pivotally connected to one end of the seat bottom tube S230 adjacent to the rear cross rod S242. In addition, an inclination angle of the backrest assembly 300 relative to the seat bottom tube S230 is adjustable. The second portion S200 further includes a support belt S270. As shown in FIG. 31, two support belts S270 may be provided. The two support belts S270 are arranged to be bilaterally symmetrical with respect to the entire child carrying device. Each of the support belts S270 is fixed between the seat bottom tube S230 and the holder 4 of the child carrying device, and as shown in FIG. 31, the support belt S270 is arranged closer to the rear cross rod S242, so as to provide a better support for the foldable carrier 10.

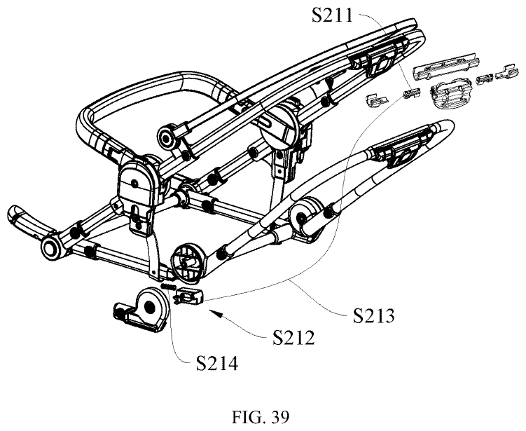

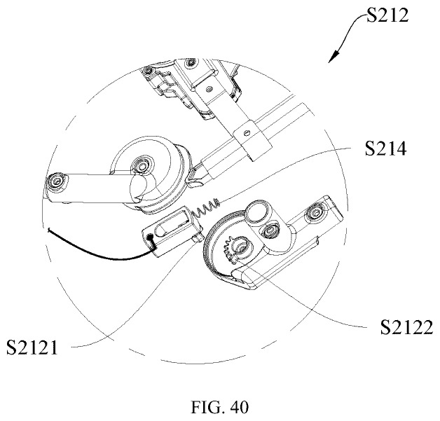

In an embodiment of the present application, the backrest assembly 300 includes a backrest body 310 and backrest support assemblies 320 connected to two ends of the backrest body 310, and further includes a second folding mechanism S210 (as shown in FIGS. 39 and 40) as the above adjustment assembly. The second folding mechanism S210 is arranged on the backrest body 310 to facilitate an operation. The two ends of the backrest body 310 are respectively connected to the backrest support assemblies 320 arranged on the two sides of the seat body 110. The second folding mechanism S210 is configured to adjust an inclination angle of the backrest support assembly 320 on the two sides, to provide the child with comfortable seated (lying) angles as required. The backrest assembly 300 has an unfolded position and a folded position.

Specifically, referring to FIGS. 39 and 40, which show a specific configuration of the second folding mechanism S210 according to an embodiment of the present application. The second folding mechanism S210 mainly includes a control member S211 as the above operating mechanism. The control member S211 is arranged on the backrest assembly 300 of the child carrying device. In addition, the second folding mechanism S210 further includes an adjustment member S212 as the above driving mechanism. The adjustment member S212 is arranged at a connection between the backrest assembly 300 and the seat bottom tube S230. The adjustment member S212 is configured to adjust an inclination angle of the backrest assembly 300 relative to the seat assembly 100, and specifically, adjust an inclination angle of the backrest assembly 300 relative to the seat bottom tube S230. To realize the control of the control member S211 over the adjustment member S212, a pulling member S213 is further arranged between the control member S211 and the adjustment member S212. The control member S211 is connected to the adjustment member S212 through the pulling member S213. When the backrest assembly 300 is in the unfolded position, the control member S211 is operable to drive the adjustment member S212 to enable the inclination angle of the backrest assembly 300 relative to the seat bottom tube S230 to be adjusted at multiple angles. In addition, the second folding mechanism S210 further includes a reset member S214 configured to reset the adjustment member S212. Referring to FIG. 40 again, FIG. 40 is a schematic enlarged exploded view showing another configuration of the second folding mechanism S210. As shown in FIG. 40, the adjustment member S212 further includes a backrest adjustment locking member S2121 and a backrest adjustment locking gear S2122. As shown in FIG. 40, the backrest adjustment locking member S2121 is provided with a protruding portion. The protruding portion is engaged with a plurality of teeth on the backrest adjustment locking gear S2122, so that the backrest adjustment locking member S2121 and the backrest adjustment locking gear S2122 are fitted with each other to lock the inclination angle of the backrest assembly 300 relative to the seat bottom tube S230 in different positions, thereby meeting different use requirements.

The second folding mechanism S210 according to the present application may be of any existing known structure, provided that the backrest assembly 300 can be pivoted relative to the seat bottom tube S230 (that is, relative to the seat assembly 100) so as to realize pivotal folding between the backrest assembly 300 and the seat bottom tube S230 and different inclined positions of the backrest assembly 300 relative to the seat bottom tube S230.

The first folding mechanism S110 according to the present application may have the same configuration as that of the second folding mechanism S210, so that the seat tube upper portion S130 and the seat tube lower portion S140 are folded relative to each other.

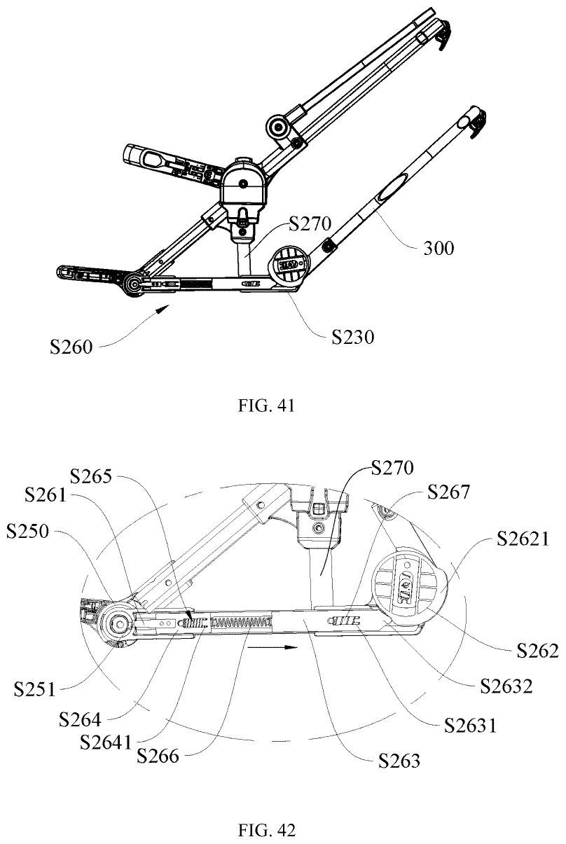

The second portion S200 according to the present application further includes the folding locking mechanism S260. In the present application, FIGS. 41 and 42 show a specific configuration of the folding locking mechanism S260. As shown in FIG. 41, which is a schematic diagram showing the folding locking mechanism S260 in a locked state, the folding locking mechanism S260 is arranged between the seat bottom tube S230 and the front cross rod S241 of the child carrying device (with reference to FIG. 31 together). Referring again to FIG. 42, FIG. 42 is a schematic enlarged view showing a specific configuration of the folding locking mechanism S260 in an unlocked state. In order to clearly show the folding locking mechanism S260, illustration of part of the support belt S270 is omitted in FIGS. 41 and 42. As shown in FIGS. 41 and 42, the folding locking mechanism S260 mainly includes a locking pin S261, a rotating member S262, and a driving member S263. When the child carrying device is in a normal use state, the locking pin S261 extends into the connecting portion S250 configured to connect the seat bottom tube S230 and the front cross rod S241, specifically into a recess S251 arranged in the connecting portion S250. According to another embodiment of the present application, the locking pin S261 extends into the front cross rod S241, for example, may extend into a recess arranged in the front cross rod S241. The rotating member S262 is connected to the backrest assembly 300 of the child carrying device, and rotates along with rotation of the backrest assembly 300. The rotating member S262 is provided with a protrusion S2621. According to an embodiment of the present application, the protrusion S2621 is arranged radially outward along a circumferential portion of the rotating member S262, and extends approximately ½ of the arc length of the circumferential portion of the rotating member S262. The driving member S263 is arranged between the locking pin S261 and the rotating member S262. The driving member S263 can drive the locking pin S261 to move by means of the rotation of the rotating member S262. According to an embodiment of the present application, the folding locking mechanism further includes a fixing member S264. The fixing member S264 is arranged between the locking pin S261 and the driving member S263. According to an embodiment of the present application, the fixing member S264 is provided with a fixing member inner groove S2641. Correspondingly, the driving member S263 is provided with a driving member inner groove S2631. A first elastic member S265 is arranged in the fixing member inner groove S2641. A third elastic member S267 is arranged in the driving member inner groove S2631. A second elastic member S266 is arranged between the fixing member S264 and the driving member S263. In addition, according to an embodiment of the present application, an end of the driving member S263 adjacent to the rotating member S262 is provided with a protrusion S2632. The protrusion S2632 is in contact with the protrusion S2621 of the rotating member S262 or the circumferential portion of the rotating member S262.

Based on the folding locking mechanism S260 of the present application, when the child carrying device is in the normal use state, the locking pin S261 is inserted into the recess S251 arranged in the connecting portion S250 between the seat bottom tube S230 and the front cross rod S241 or inserted into the groove arranged in the front cross rod S241. On the other side, the protrusion S2632 of the driving member S263 contacts and abuts against the protrusion S2621 of the rotating member S262, so that a position of the seat bottom tube S230 can be locked, which prevents accidental folding of the seat bottom tube S230 due to an improper force, improves safety of use of the child carrying device, and may also facilitate the child carrying device to pass overturning and impact tests. When the backrest assembly 300 is rotated toward the seat bottom tube S230, the rotating member S262 is rotated along with the backrest assembly 300, so that the protrusion S2632 of the driving member S263 is out of contact with the protrusion S2621, and comes into contact with the circumferential portion of the rotating member S262. Since the protrusion S2621 is arranged radially outward along the circumferential direction of the rotating member S262, a height of the protrusion S2621 is greater than that of the circumferential portion of the rotating member S262. Due to a height difference between the protrusion S2621 and the circumferential portion of the rotating member S262, the driving member S263 is moved in a direction indicated by an arrow in FIG. 42. Under the action of the first elastic member S265, the second elastic member S266, and the third elastic member S267, the locking pin S261 is separated from the recess S251 of the connecting portion S250, so that the seat of the child carrying device can be folded smoothly. Based on the folding locking mechanism S260 as described above, the seat bottom tube S230 can be locked when the child carrying device is in the normal use state, that is, a relative position of the seat bottom tube S230 can be locked, which prevents accidental folding of the seat of the child carrying device and improves safety of use of the child carrying device.

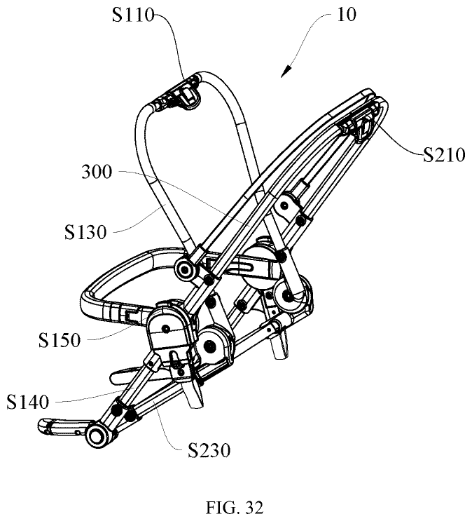

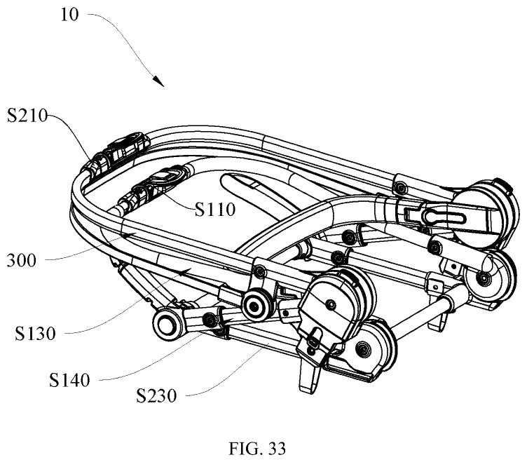

Since both the first portion S100 and the second portion S200 of the foldable carrier 10 according to the present application can be folded, a folded size of the child carrying device can be smaller. A folding process of the child carrying device according to the present application will be described below with reference to FIGS. 32 and 33. FIG. 32 is a schematic diagram of the backrest assembly 300 of the foldable carrier 10 of the child carrying device during the folding process according to the present application, and FIG. 33 is a schematic diagram of the foldable carrier 10 of the child carrying device in a completely folded state according to the present application. In the first portion S100, through the first folding mechanism S110, the seat tube upper portion S130 and the seat tube lower portion S140 may be pivotally folded relative to each other. In the second portion S200, through the second folding mechanism S210, the backrest assembly 300 and the seat bottom tube S230 may also be pivotally folded relative to each other. In addition, between the first portion S100 and the second portion S200, the seat tube lower portion S140 and the seat bottom tube S230 may also be pivotally folded relative to each other. With the seat tube upper portion S130 and the seat tube lower portion S140 completely folded relative to each other, the backrest assembly 300 and the seat bottom tube S230 completely folded relative to each other, and the seat tube lower portion S140 and the seat bottom tube S230 completely folded relative to each other, the foldable carrier 10 of the child carrying device may finally reach a completely folded state, as shown in FIG. 33. In addition, pivotal folding between the seat tube upper portion S130 and the seat tube lower portion S140 and/or pivotal folding between the backrest assembly 300 and the seat bottom tube S230 and/or pivotal folding between seat tube lower portion S140 and the seat bottom tube S230 may be selectively performed according to a specific situation and a requirement. The inclination angle of the backrest assembly 300 relative to the seat bottom tube S230 may be adjusted independently, improving convenience of use. The foldable carrier 10 according to the present application can be completely folded through a simple structure, so the cost is low and the operation is convenient.

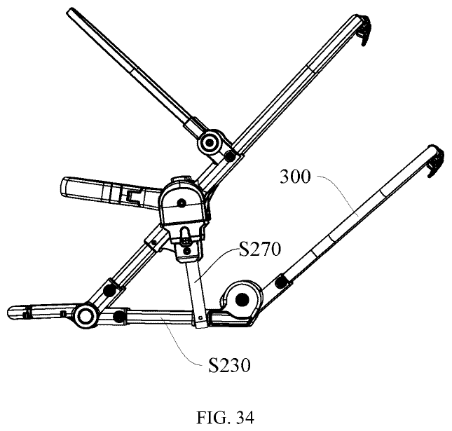

In addition to the pivotal folding between the backrest assembly 300 and the seat bottom tube S230, the inclination angle of the backrest assembly 300 relative to the seat bottom tube S230 may also be adjusted according to a use requirement. According to an embodiment, the inclination angle of the backrest assembly 300 relative to the seat bottom tube S230 is adjustable in four levels. Two inclination angles of the backrest assembly 300 relative to the seat bottom tube S230 are shown in FIGS. 34 and 35 of the present application. In FIG. 34, an angle formed between the backrest assembly 300 and the seat bottom tube S230 is relatively large, which is suitable for younger babies and can meet their requirement for half-lying. In FIG. 35, the angle formed between the backrest assembly 300 and the seat bottom tube S230 is relatively small, which is suitable for older children and can meet their riding requirements.

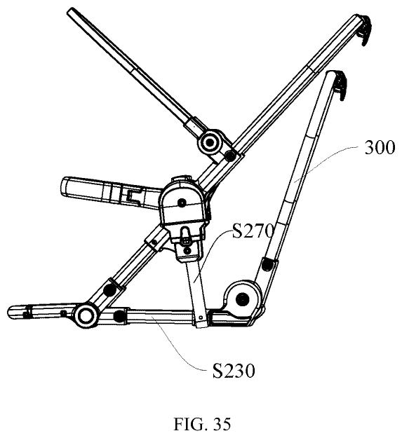

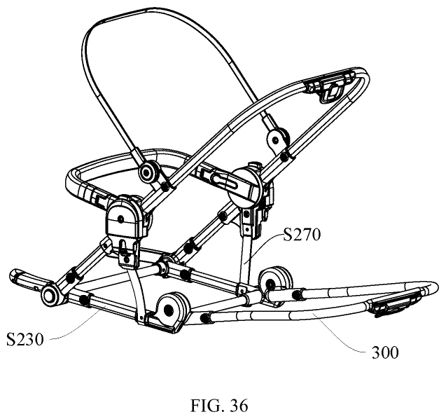

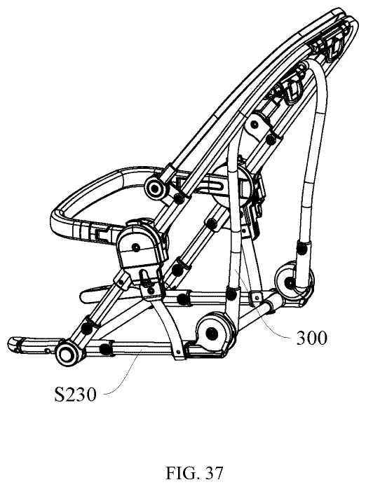

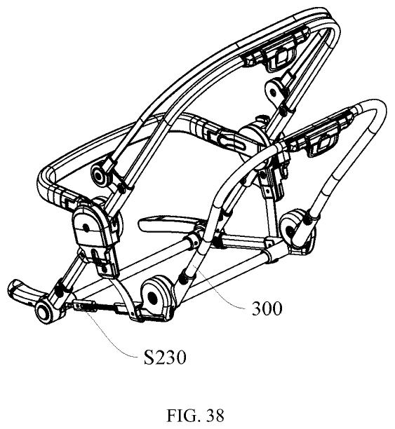

Several different poses of the foldable carrier 10 according to the present application are further shown in FIGS. 36, 37, and 38 of the present application. Such figures further show that, based on different inclination angles of the backrest assembly 300 relative to the seat bottom tube S230, the foldable carrier 10 of the child carrying device is in different poses to be adapted for riding requirements of children of different ages. For example, FIG. 36 shows a pose of the foldable carrier 10 suitable for riding requirements of relatively young children, or it is required to adjust the backrest assembly 300 to have a more inclined pose after relatively older children fall asleep in the child carrying device. FIGS. 37 and 38 show poses of the foldable carrier 10 suitable for riding requirements of relatively older children.

In addition, the seat folding mechanism of the child carrying device according to the present application has a simple structure, a low cost, and a convenient operation. Moreover, as described above, a position of the backrest assembly 300 may be adjusted independently, improving convenience of use.

Although the foldable carrier 10 shown in FIG. 1 is slightly different from the foldable carrier 10 shown in FIG. 30 in configuration, it should be understood that structural features of the foldable carrier 10 shown in FIG. 1 and the foldable carrier 10 shown in FIG. 30 may be combined arbitrarily to obtain a seat assembly with structural features not exhaustively illustrated herein. In order to avoid redundant descriptions, various combinations of the above structural features of the seat assembly will not be repeatedly described herein.

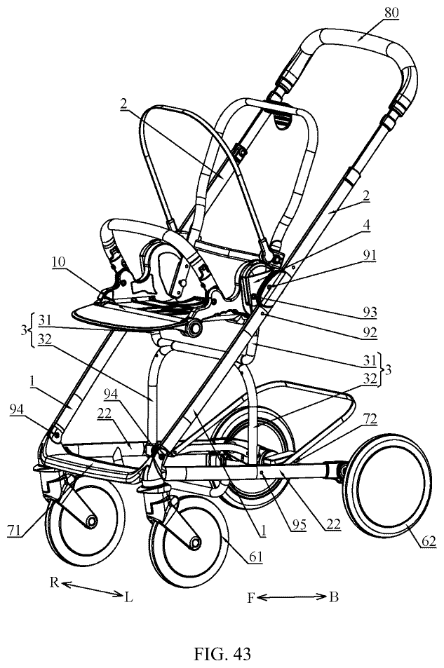

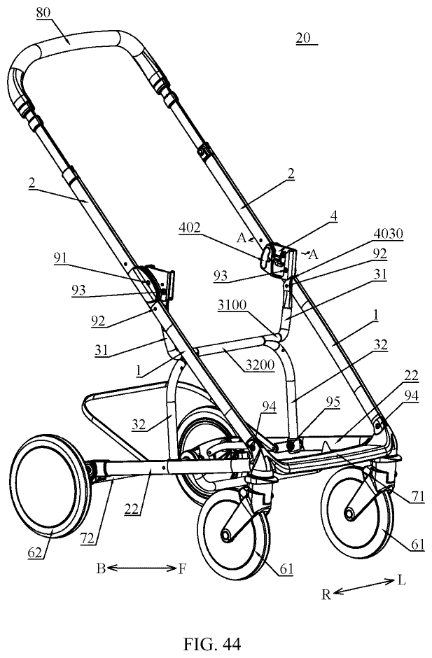

In various embodiments of the present application, according to different types of child carrying devices, the carrier frame 20 may be a fixed carrier frame without wheels at the bottom or a movable carrier frame with wheels at the bottom. According to an embodiment the present application, the carrier frame 20 is a foldable carrier frame. Therefore, the carrier frame 20 has an unfolded state and a folded state. FIG. 43 is another perspective view schematically showing the child carrying device shown in FIG. 1. FIG. 44 is a perspective view schematically showing carrier frame of the child carrying device shown in FIG. 43. It should be noted that, unless otherwise specified and defined, the orientation terms “front”, “back”, “left”, and “right” in the embodiments of the present application based on the orientation when the child carrying device is in a normal use state, that is, the carrier frame 20 is in the unfolded state, and in the figures, the “front” and “back” directions are schematically illustrated by arrows F and B, and the “left” and “right” directions are schematically illustrated by arrows L and R. These orientation terms are intended only to make the description of the embodiments of the present application clearer, and are not intended to improperly limit the protection scope of the present application. The child carrying device and the carrier frame 20 will be described below with reference to the accompanying drawings and specific embodiments.

Referring to FIGS. 43 and 44, the carrier frame 20 has a basically bilaterally symmetrical structure, generally including two front leg frames 1, two handle frames 2, two support frames 3, two holders 4, two underframes 22, etc., that are arranged in bilateral symmetry. Upper ends of the two handle frames 2 are connected to each other through a handle portion 80. The front leg frame 1, the handle frame 2, and the handle portion 80 form the above handle member 21.

Referring to FIG. 44, the two underframes 22 are spaced apart in a left-right direction, and the two underframes 22 may be connected by at least one connecting member arranged transversely. The connecting member includes, for example, a pedal frame 71 connected between front ends of the two underframes 22. The connecting member may further include a cross rod 72 connected between rear ends of the two underframes 22. The wheels 23 include two front wheels 61 and two rear wheels 62. The front wheels 61 may be universal wheels, and are mounted at front ends of the underframes 22 respectively. The rear wheels 62 are mounted at rear ends of the underframes 22 respectively. For example, the rear wheels 62 may be mounted at two ends of the cross rod 72 respectively, and an axis of rotation of each of the rear wheels 62 roughly overlaps with, for example, an axis of the cross rod 72.

Referring to FIG. 44, the two front leg frames 1 extend obliquely and are spaced apart in the left-right direction, and a lower end of each of the front leg frames 1 is pivotally connected to the front end of the underframe 22 on the corresponding side through a fourth pivot 94. Therefore, the front wheel 61 is also mounted at the lower end of each of the front leg frames 1. The two handle frames 2 are spaced apart in the left-right direction. A lower end of each of the handle frames 2 is pivotally connected to an upper end of the front leg frame 1 on the corresponding side through a first pivot 91. When unfolded, the handle frame 2 and the front leg frame 1 connected to each other are, for example, in a shape of a straight line. Since the upper ends of the two handle frames 2 are connected to each other through the handle portion 80, and a parent may push the child carrying device to move by holding the handle portion 80. In some embodiments, a length of each of the handle frames 2 may be adjusted, so that a height of the handle portion 80 is adjustable, thereby meeting use requirements of parents with different heights.

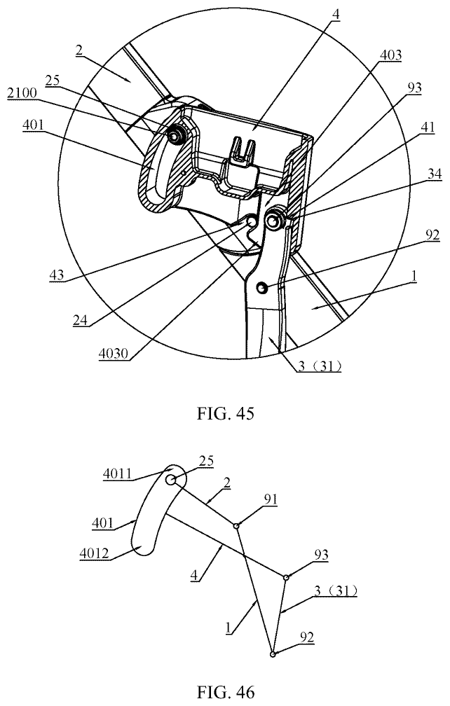

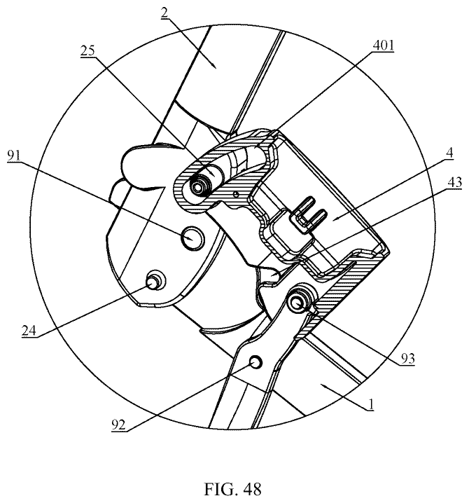

Referring to FIG. 44, in some embodiments, the front leg frame 1 and the underframe 22 on the same side are connected to each other through a corresponding support frame 3. The support frame 3 is configured to support the front leg frame 1 to keep the front leg frame 1 in an inclined state. Therefore, the carrier frame 20 may not be additionally provided with a rear leg frame. Taking the support frame 3 on the left side as an example, the support frame 3 may include an upper bracket 31 and a lower bracket 32 that are arranged in an up-down direction and are pivotally connected to each other. An upper end of the upper bracket 31 is pivotally connected to the upper end of the front leg frame 1 through a second pivot 92. The second pivot 92 is further away from an upper end portion of the front leg frame 1 than the first pivot 91 (see FIG. 48). Moreover, the upper end of the upper bracket 31 is pivotally connected to a front side of the corresponding holder 4 through a third pivot 93, and the second pivot 92 is further away from an upper end portion of the support frame 3 than the third pivot 93 (see FIG. 45). A lower end of the upper bracket 31 is pivotally connected to an upper end of the lower bracket 32 to allow the support frame 3 itself to be foldable. A lower end of the lower bracket 32 may be pivotally connected to the underframe 22 (e.g., a middle portion of the underframe 22) through a fifth pivot 95. A reference may be made to the description of the support frame 3 on the left side as above to understand a configuration of the support frame 3 on the right side and a connection relationship of the support frame 3 on the right side with the front leg frame 1, the holder 4, and the underframe 22 on the right side, and which will not be repeatedly described herein again.

Referring to FIG. 44, in this embodiment, lower ends of the upper brackets 31 on the left and right sides may be connected to each other through a first cross arm 3100 to form a U-shaped structure. Upper ends of the lower brackets 32 on the left and right sides may be connected to each other through a second cross arm 3200 to form another U-shaped structure. The first cross arm 3100 is pivotally connected to the second cross arm 3200, so that the upper brackets 31 on the two sides are associated with the lower brackets 32 on the two sides, which is beneficial to improve consistency of folding or unfolding actions of the support frames 3 on the left and right sides. The first cross arm 3100 may be pivotally connected to the second cross arm 3200 through any suitable structure. For example, in some embodiments, the second cross arm 3200 is provided with a sleeve structure or an annular ferrule for the first cross arm 3100 to extend through. It may be understood that the configuration of the support frame 3 is not limited to the above description, provided that the upper end of the support frame 3 is pivotally connected to the upper end of the front leg frame 1 through the second pivot 92, and is pivotally connected to the front side of the holder 4 through the third pivot 93.

The two holders 4 may be movably mounted on the carrier frame 20 relative to the carrier frame 20. Each of the two holders 4 is configured to be detachably engaged with the foldable carrier 10 of the child carrying device. Taking the holder 4 on the left side as an example, as described above, the front side of the holder 4 is pivotally connected to the upper end of the upper bracket 31 of the support frame 3 through the third pivot 93, and a rear side of the holder 4 is in sliding fit with a lower end of the handle frame 2. Therefore, when the carrier frame 20 is switched between the unfolded state and the folded state, the holder 4 may be switched between an effective position and an ineffective position driven by the carrier frame. The effective position of the holder 4 corresponds to the unfolded state of the carrier frame 20, and the ineffective position of the holder 4 corresponds to the folded state of the carrier frame 20. In some embodiments, referring to FIG. 45, the lower end of the handle frame 2 is provided with a connecting pin 25. The connecting pin 25 is further away from a lower end portion of the handle frame 2 relative to the first pivot 91 (see FIG. 48). The rear side of the holder 4 is provided with a sliding hole 401. The sliding hole 401 is in sliding fit with the connecting pin 25. Certainly, the sliding fit relationship between the holder 4 and the handle frame 2 may alternatively be realized through other suitable structures. For example, in some alternative embodiments, the holder 4 and the handle frame 2 may be in sliding fit through a sliding rail and a sliding groove. A reference may be made to the description of the holder 4 on the left side as above to understand a configuration of the holder 4 on the right side and a connection relationship of the holder 4 on the right side with the support frame 3 and the handle frame 2 on the right side, and which will not be repeatedly described herein again.

Referring to FIGS. 44 to 46, the sliding hole 401 includes an upper end 4011 and a lower end 4012 opposite to the upper end 4011. When the carrier frame 20 is in the unfolded state, the connecting pin 25 abuts against an end wall of the upper end 4011 of the sliding hole 401, and the front side of the holder 4 is supported by the upper end of the support frame 3. After the foldable carrier 10 is engaged to the holder 4, under the action of gravity, the foldable carrier 10 has a tendency to drive the rear side of the holder 4 to pivot downward around the third pivot 93. Since the connecting pin 25 abuts against the end wall of the upper end 4011 of the sliding hole 401 such that the rear side of the holder 4 is not allowed to pivot downward around the third pivot 93, the holder 4 is stably held in the effective position, and thus can form a reliable support for the foldable carrier 10. It should be noted that, in FIG. 46, a straight line indicated by the numeral 1 corresponds to a portion of the front leg frame 1 arranged between the first pivot 91 and the second pivot 92, and a straight line indicated by the numeral 2 corresponds to a portion of the handle frame 2 arranged between the first pivot 91 and the connecting pin 25. In practical application, referring to FIG. 44, when the carrier frame 20 is in the unfolded state, the front leg frame 1 and the handle frame 2 may be designed to be on a straight line. It can be understood that, in FIG. 46, a straight line indicated by the numeral 3 corresponds to a portion of the support frame 3 arranged between the second pivot 92 and the third pivot 93, and a straight line indicated by the numeral 4 corresponds to a portion of the holder 4 arranged between the third pivot 93 and the sliding hole 401.

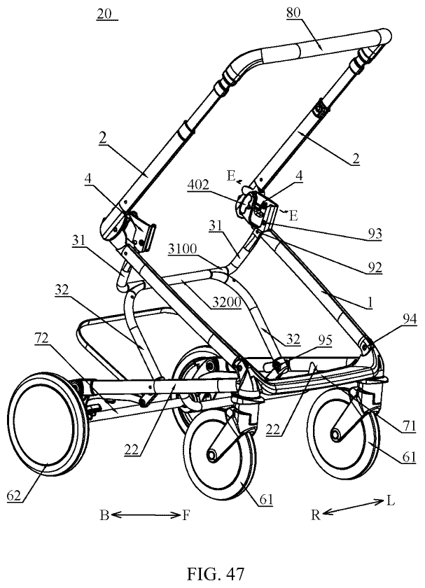

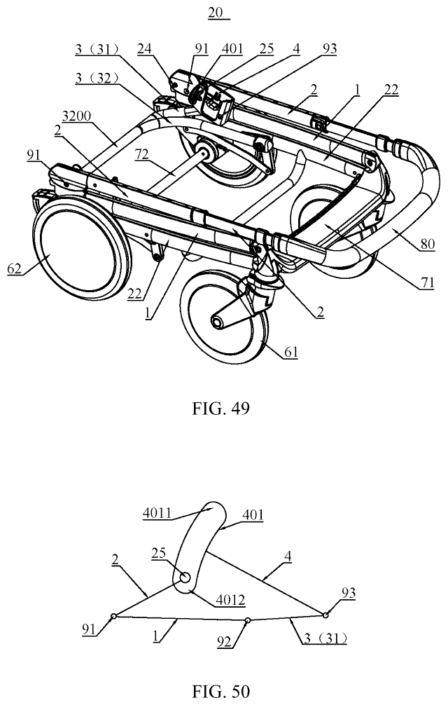

When it is required to store the infant carrier, the foldable carrier 10 may be removed from the holder 4, and then the carrier frame 20 is folded. Referring to FIGS. 47 and 48, when the carrier frame 20 is folded, a pivot joint between the upper bracket 31 and the lower bracket 32 of the support frame 3 (a connection of the first cross arm 3100 and the second cross arm 3200 in this embodiment) may be pushed backward, so that the upper bracket 31 and the lower bracket 32 approach each other such that the support frame 3 itself is folded, the front leg frame 1 is rotated backward and downward around the fourth pivot 94 to approach the underframe 22, and the handle frame 2 is rotated forward and downward around the first pivot 91 to approach the front leg frame 1. When the front leg frame 1, the handle frame 2, and the support frame 3 of the carrier frame 20 perform the above folding actions, the carrier frame 20 drives the holder 4 to move by the connecting pin 25 and the third pivot 93, so that the holder 4 is switched from the effective position shown in FIG. 44 to the ineffective position shown in FIG. 49. More specifically, the connecting pin 25 is slid in the sliding hole 401 so as not to interfere with the folding actions of the front leg frame 1, the handle frame 2, and the support frame 3. When the connecting pin 25 is slid to the lower end 4012 in the sliding hole 401, the connecting pin 25 may press the lower end 4012 downward until the carrier frame 20 is completely folded. Referring to FIGS. 49 and 50, after the carrier frame 20 reaches the folded state, the connecting pin 25 is at the lower end of the sliding hole 401. In addition, as can be seen from FIG. 49, when the carrier frame 20 is in the folded state, the rear side of the holder 4 is raised relative to the front side thereof. In this way, the rear side of the holder 4 does not hinder the lower bracket 32 and the front leg frame 1 from approaching each other, which helps to reduce a packaging volume of the entire carrier frame 20 after being folded. When the carrier frame 20 is required again to be unfolded to the unfolded state shown in FIG. 44, the handle frame 2 is rotated backward and upward around the first pivot 91, the front leg frame 1 is rotated forward and upward around the fourth pivot 94, the pivot joint between the upper bracket 31 and the lower bracket 32 is moved forward to unfold the support frame 3, and the connecting pin 25 is slid in the sliding hole 401 so as not to interfere with the unfolding actions of the front leg frame 1, the handle frame 2, and the support frame 3. When the front leg frame 1, the handle frame 2, and the support frame 3 of the carrier frame 20 perform the above folding actions, the carrier frame 20 drives the holder 4 to move by the connecting pin 25 and the third pivot 93, so that the holder 4 is switched from the ineffective position shown in FIG. 49 to the effective position shown in FIG. 44.

The implementations of the carrier frame 20 according to the embodiments of the present application and the connection relationship between the carrier frame 20 and the holder 4 are not limited to the above description. By rationally designing the connection relationship among various components of the carrier frame 20 and the connection relationship between the components of the carrier frame 20 and the holder 4, when the carrier frame 20 is subjected to an external force, and is unfolded from the folded state, there is no need to manually operate the holder 4, and the carrier frame 20 directly drives the holder 4 to perform adaptive rotation, so that the holder 4 also reaches the effective position capable of reliably supporting the foldable carrier 10 when the carrier frame 20 reaches the unfolded state. Similarly, when the carrier frame 20 is subjected to an external force, and is folded from the unfolded state, there is no need to manually operate the holder 4, and the carrier frame 20 directly drives the holder 4 to perform adaptive rotation, so that the holder 4 also reaches the ineffective position when the carrier frame 20 reaches the folded state. The carrier frame 20 according to the embodiments of the present application may not be additionally provided with a locking mechanism configured to hold the holder 4 in the effective position. When the carrier frame 20 changes its pose, there is no need to manually adjust the position of the holder 4, which is beneficial to a compact structure and a reduced cost of the carrier frame 20 on the one hand, and improves convenience of the operation of the carrier frame 20 on the other hand.

Referring to FIGS. 45 and 46, in this embodiment, the sliding hole 401 is in a shape of an arc. In some embodiments, the connecting pin 25 is centrally provided with a threaded hole 2100, and a bolt (not shown in the figure) is inserted into the threaded hole 2100 to fix relative positions of the handle frame 2 and the holder 4 in the left-right direction. In some alternative embodiments, a sinking platform (not shown in the figure) may be arranged in the sliding hole 401, and a head of a bolt may be embedded in the sinking platform. In addition, referring to FIG. 47, a cover plate 402 may be arranged on the holder 4. The cover plate 402 covers the sliding hole 401 on a side of the holder 4 away from the handle frame 2, to prevent debris from entering the sliding hole 401 and affecting the sliding of the connecting pin 25. A side of the sliding hole 401 facing the handle frame 2 may be directly covered by the handle frame 2.

Referring to FIG. 45 again, the front side of the holder 4 may be provided with a first engaging structure 41, and the upper end of the support frame 3 is provided with a second engaging structure 34. When the carrier frame 20 is in the unfolded state, the first engaging structure 41 abuts against the second engaging structure 34 to limit upward pivoting of the rear side of the holder 4 around the third pivot 93. In this way, it is more helpful to hold the holder 4 stably in the effective position, and can prevent forward tipping of the foldable carrier 10 and the holder 4 when the infant carrier brakes suddenly in an emergency. The first engaging structure 41 and the second engaging structure 34 may be a first step and a second step fitted with each other, or a first protuberance and a first recess fitted with each other, or any other suitable structures. In this embodiment, the front side of the holder 4 is further provided with an accommodating portion 403. The accommodating portion 403 includes a bottom opening 4030. The upper end of the upper bracket 31 of the support frame 3 extends into the accommodating portion 403 via the bottom opening 4030, and the third pivot 93 may be supported by a sidewall of the accommodating portion 403. The second engaging structure 34 is arranged close to the upper end of the support frame 3. When the carrier frame 20 is in the unfolded state, the second engaging structure 34 is arranged in the accommodating portion 403. Correspondingly, the first engaging structure 41 is arranged in the accommodating portion 403. It can be understood that, when the carrier frame 20 is folded, the first engaging structure 41 and the second engaging structure 34 may not interfere with the relative rotation between the holder 4 and the support frame 3.

Still referring to FIG. 45, a third engaging structure 43 is further arranged on the bottom of the holder 4. The third engaging structure 43 is arranged between the sliding hole 401 and the third pivot 93. A fourth engaging structure 24 is further arranged on the handle frame 2. When the carrier frame 20 is in the unfolded state, the fourth engaging structure 24 abuts against the third engaging structure 43. The third engaging structure 43 abutting against the fourth engaging structure 24 provides an auxiliary support for a middle portion of the holder 4. In this embodiment, the third engaging structure 43 is an engaging groove, and the fourth engaging structure 24 is a post extending laterally from the handle frame 2 toward the holder 4. Certainly, the configurations of the third engaging structure 43 and the fourth engaging structure 24 are not limited to the above description. It can be understood that, when the carrier frame 20 is folded, the third engaging structure 43 and the fourth engaging structure 24 may not interfere with relative movement between the holder 4 and the handle frame 2. Referring to FIG. 48, the first pivot 91 is arranged, for example, between the post and the connecting pin 25.

It should be noted that the carrier frame 20 according to the embodiments of the present application is not limited to the above description, and the carrier frame 20 may be, for example, modified as follows.

1. In some alternative embodiments, the position of the connecting pin 25 and the position of the sliding hole 401 may be interchanged. That is, the connecting pin 25 may be arranged on the rear side of the holder 4, and the sliding hole 401 may be arranged at the lower end of the handle frame 2.

2. In some alternative embodiments, an angle limiting device may be arranged between the first cross arm 3100 and the second cross arm 3200 to limit pivotal angles of the first cross arm 3100 and the second cross arm 3200, so as to help to keep the upper bracket 31 and the lower bracket 32 on the same side in the unfolded state as shown in FIG. 44, so that the front leg frames 1 on the two sides are respectively supported reliably by the support frames 3 on the corresponding sides. More specifically, when the first cross arm 3100 and the second cross arm 3200 are rotated relative to each other to enable the upper bracket 31 and the lower bracket 32 to be unfolded in place, the angle limiting device limits a relative rotational position of the first cross arm 3100 and the second cross arm 3200, thereby keeping the upper bracket 31 and the lower bracket 32 on the same side in the unfolded state.

3. In some alternative embodiments, the upper bracket 31 and the lower bracket 32 on the left and right sides may not be associated with each other, provided that the upper bracket 31 and the lower bracket 32 on the same side are pivotally connected to each other to allow the support frame 3 to be unfolded or folded. In some other alternative embodiments, the support frame 3 on the same side is not limited to include the upper bracket 31 and the lower bracket 32 as described above, which may include, for example, a plurality of brackets sequentially pivotally connected in the up-down direction. These brackets may be unfolded or folded, which corresponds to the unfolding or folding of the support frame 3 itself.

4. In some alternative embodiments, the carrier frame 20 may not be provided with the underframe 22, the front wheel 61 is connected to the lower end of the front leg frame 1, and the support frame 3 may be used as, for example, a rear leg frame and is connected to the rear wheel 62. To ensure structural strength of the rear leg frame, the support frame 3 itself may not, for example, be folded. When it is required to fold the carrier frame 20, the support frame 3 may be rotated around the second pivot 92 to approach the front leg frame 1.

According to a first aspect of the present application, a foldable carrier includes: a seat assembly; an armrest assembly pivotable relative to the seat assembly and movable between a folded position and an unfolded position, the armrest assembly being provided with a locking portion; a backrest assembly having a folded position and an unfolded position; a linkage assembly movably connected to the backrest assembly; and a locking member, one end of the locking member being pivotally connected to the linkage assembly, the other end of the locking member being capable of being fitted with the locking portion, the backrest assembly being folded in a direction approaching the armrest assembly to drive, through the linkage assembly, the locking member to be separated from the locking portion.

In the above foldable carrier, the armrest assembly may be pivoted relative to the seat assembly and be moved between a folded position and an unfolded position, and the backrest assembly also has the folded position and the unfolded position. When the foldable carrier is unfolded, the locking member is fitted with the locking portion, so as to lock the armrest assembly to the unfolded position. When it is required to fold the foldable carrier, only the backrest assembly is required to be folded in a direction approaching the armrest assembly, and the locking member pivotally connected to the linkage assembly can be driven, through the linkage assembly, to be separated from the locking portion, thereby releasing the armrest assembly, so that the armrest assembly can be folded along with the backrest assembly in a linked manner. In this way, the foldable carrier can realize linked folding of the armrest assembly along with the backrest assembly through a simple structure, which is convenient to use.

In an embodiment of the present application, the linkage assembly includes a driving member and a linkage member. One end of the linkage member is pivotally connected to the locking member, the other end of the linkage member is slidably connected to the driving member. The driving member is pivotally connected to the backrest assembly.

In an embodiment of the present application, the driving member is provided with a driving groove arranged in a length direction of the driving member, and the other end of the linkage member is provided with a linkage post. The linkage post is inserted into the driving groove and movable in the driving groove.

In an embodiment of the present application, the linkage assembly further includes a first reset member. The first reset member is arranged in the driving groove. Two ends of the first reset member respectively abuts against the linkage post and an inner wall of the driving groove.

In an embodiment of the present application, the backrest assembly includes a fixing member. The fixing member is pivotally connected to the seat assembly at a first pivot point, and the driving member is pivotally connected to the fixing member at a second pivot point. The second pivot point is offset from the first pivot point.

In an embodiment of the present application, the linkage assembly further includes a driving pin arranged on the driving member, and the driving member is pivotally connected to the fixing member through the driving pin.

In an embodiment of the present application, the seat assembly includes a side plate. The fixing member is pivotally connected to the side plate at the first pivot point. The linkage assembly and the locking member are arranged on a side of the side plate facing away from the fixing member. The side plate is provided with a guide groove. The driving pin extends through the guide groove to be pivotally connected to the fixing member at the second pivot point. The guide groove has a first position and a second position. The driving pin moves to the first position when the backrest assembly is in the folded position, and the driving pin moves to the second position when the backrest assembly is in the unfolded position.

In an embodiment of the present application, the guide groove is an arc groove bent around the first pivot point.

In an embodiment of the present application, the seat assembly further includes a side cover. The side cover covers a side of the side plate facing away from the fixing member to form an accommodating space. The linkage assembly and the locking member are arranged in the accommodating space.

In an embodiment of the present application, the armrest assembly includes an armrest support rod. The locking portion is a locking groove formed on the armrest support rod, and the locking member is a locking pin.

In an embodiment of the present application, the armrest support rod is pivotally connected to the seat assembly at a third pivot point. A first circle tangent to a bottom wall of the locking groove is drawn with the third pivot point as a center, and when the armrest assembly moves to the unfolded position, the locking pin is capable of being inserted into the locking groove in a radial direction of the first circle.

In an embodiment of the present application, the foldable carrier further includes a second reset member. Two ends of the second reset member are respectively fixed to the seat assembly and the armrest assembly. The second reset member constantly enables the armrest assembly to move toward the unfolded position.

In an embodiment of the present application, the backrest assembly further includes an angle adjustment mechanism. The angle adjustment mechanism is configured to adjust an angle of the backrest assembly relative to the seat assembly.

In an embodiment of the present application, the angle adjustment mechanism includes an angle adjustment locking member. The angle adjustment locking member is movably arranged on the backrest assembly. The seat assembly is provided with a plurality of locking holes. The angle adjustment locking member is capable of being fitted and locked into any one of the locking holes, so that the backrest assembly is fixed at different angles relative to the seat assembly.

In an embodiment of the present application, the angle adjustment locking member has a first driving position and a second driving position. When the angle adjustment locking member is in the first driving position, the angle adjustment locking member is inserted into any one of the locking holes, and the backrest assembly is relatively fixed to the seat assembly. When the angle adjustment locking member is in the second driving position, the angle adjustment locking member is withdrawn from the any one of the locking holes, and the backrest assembly is rotatable relative to the seat assembly.

In an embodiment of the present application, the angle adjustment mechanism further includes an angle adjustment reset member. The angle adjustment reset member constantly enables the angle adjustment locking member to move toward the first driving position.

In an embodiment of the present application, the angle adjustment mechanism further includes an operating assembly and a driving assembly. The operating assembly is operable to drive, through the driving assembly, the angle adjustment locking member to move toward the second driving position.

In an embodiment of the present application, the driving assembly includes a rod member and a driving pin. The rod member is provided with a driving slope, the driving pin is fixed to the angle adjustment locking member, and the driving pin abuts against the driving slope. When the driving assembly is operated, the rod member is movable and drives the driving pin to move by the driving slope, and drives the angle adjustment locking member to move toward the second driving position by the driving pin.

In an embodiment of the present application, the operating assembly includes an operating handle, a pulling reset member, a connecting member, and a pulling member.

Two ends of the pulling member are respectively connected to the connecting member and the rod member. The pulling reset member is arranged between the operating handle and the connecting member. The operating handle is operable to drive the connecting member to move by the pulling reset member and pull the pulling member by the connecting member. The pulling reset member constantly enables the operating handle to move in a direction opposite to a direction in which the operating handle is operated.

In an embodiment of the present application, the seat assembly includes a seat body and a side plate. The armrest assembly includes an armrest support rod pivotable relative to the seat assembly. The backrest assembly includes a backrest support assembly movably connected to the linkage assembly. Two opposite sides of the seat body are each provided with the side plate, the armrest support rod, the backrest support assembly, the linkage assembly, and the locking member. On either of the two opposite sides of the seat body, the backrest support assembly is pivotally connected to the side plate.

According to a second aspect of the present application, a child carrying device includes a carrier frame and the foldable carrier according to any one of the above embodiments.

In an embodiment of the present application, the child carrying device is a bassinet, a car seat, a bouncing chair, a child stroller, a high chair, or a child dining chair.

According to a third aspect of the present application, a foldable carrier includes: a seat tube; seat bottom tubes; a backrest assembly pivotally connected to end portions of the seat bottom tubes; and a front cross rod arranged between the seat bottom tubes at an end away from the backrest assembly, wherein the foldable carrier further includes a folding locking mechanism. The folding locking mechanism is arranged between the seat bottom tubes and the front cross rod. When the folding locking mechanism is in a locked state, the seat tube and the seat bottom tubes are locked to an unfolded state. When the folding locking mechanism is in an unlocked state, the seat tube and the seat bottom tubes are pivotable relative to each other.

In an embodiment of the present application, the folding locking mechanism includes: a locking pin, the locking pin extending into a recess arranged in a connecting portion connecting the seat bottom tubes and the front cross rod when the foldable carrier is in a normal use state; a rotating member connected to the backrest assembly of the foldable carrier and rotating along with rotation of the backrest assembly, the rotating member being provided with a protrusion; and a driving member arranged between the locking pin and the rotating member, and the driving member being capable of driving the locking pin to move by means of rotation of the rotating member.

In an embodiment of the present application, the folding locking mechanism further includes a fixing member. The fixing member is arranged between the locking pin and the driving member.

In an embodiment of the present application, the fixing member is provided with a fixing member inner groove, and the driving member is provided with a driving member inner groove. A first elastic member is arranged in the fixing member inner groove, a third elastic member is arranged in the driving member inner groove, and a second elastic member is arranged between the fixing member and the driving member.

In an embodiment of the present application, the protrusion is arranged radially outward along a circumferential portion of the rotating member, and extends approximately ½ of an arc length of the circumferential portion of the rotating member.

In an embodiment of the present application, an end of the driving member adjacent to the rotating member is provided with a protrusion. The protrusion is in contact with the protrusion or the circumferential portion of the rotating member.

In an embodiment of the present application, the locking pin extends into a recess arranged in the front cross rod when the foldable carrier is in the normal use state.

In an embodiment of the present application, the foldable carrier further includes a rear cross rod. The rear cross rod is arranged between the seat bottom tubes at an end adjacent to the backrest assembly.

In an embodiment of the present application, the seat tube includes a seat tube upper portion and a seat tube lower portion. The seat tube upper portion is connected to the seat tube lower portion through a pivot base. The seat tube lower portion is pivotally connected to the seat bottom tubes. When the folding locking mechanism is in the locked state, the seat tube lower portion and the seat bottom tubes are locked to the unfolded state. When the folding locking mechanism is in the unlocked state, the seat tube lower portion and the seat bottom tubes are pivotable relative to each other.

According to a fourth aspect of the present application, a child carrying device, including a foldable carrier, a carrier frame, and a holder configured for connecting the foldable carrier and the carrier frame, wherein the foldable carrier includes: a first portion including a seat tube; and a second portion arranged below the first portion and including a backrest assembly, seat bottom tubes, a front cross rod, and a second folding mechanism. The backrest assembly is pivotally connected to one end of each of the seat bottom tubes. The front cross rod is arranged between the seat bottom tubes at an end away from the backrest assembly. The second folding mechanism is arranged on the backrest assembly and configured to adjust an inclination angle of the backrest assembly relative to each of the seat bottom tubes. The second portion further includes the folding locking mechanism of the foldable carrier as described above.

In an embodiment of the present application, the seat tube includes a seat tube upper portion and a seat tube lower portion. The seat tube upper portion and the seat tube lower portion are pivotally connected to each other through a pivot base.

In an embodiment of the present application, the second folding mechanism enables the inclination angle of the backrest assembly relative to each of the seat bottom tubes to be adjustable in four levels.

In an embodiment of the present application, the second folding mechanism includes: a control member arranged on the backrest assembly; an adjustment member arranged at a connection between the backrest assembly and each of the seat bottom tubes and configured to adjust the inclination angle of the backrest assembly relative to each of the seat bottom tubes; a pulling member arranged between the control member and the adjustment member to connect the control member and the adjustment member; and a reset member configured to reset the adjustment member.

In an embodiment of the present application, the adjustment member includes: a backrest adjustment locking member; and a backrest adjustment locking gear engaged with the backrest adjustment locking member to lock the inclination angle of the backrest assembly relative to the seat bottom tubes in different positions.

In an embodiment of the present application, the child carrying device further includes a support belt. The support belt is fixed between the seat bottom tubes and the holder of the child carrying device to support the foldable carrier.

In an embodiment of the present application, the seat bottom tubes and the seat tube lower portion are pivotally connected to each other.

In an embodiment of the present application, the carrier frame includes a handle member, an underframe, and wheels. The handle member extends obliquely upward and backward from the wheels.

In an embodiment of the present application, the seat tube includes a seat tube upper portion and a seat tube lower portion pivotally connected to the seat tube upper portion. The first portion further includes a first folding mechanism. The first folding mechanism is arranged on the seat tube upper portion and configured to enable the seat tube upper portion and the seat tube lower portion to pivot relative to each other.

According to a fifth aspect of the present application, a carrier frame of a child carrying device is provided. A holder is mounted on the carrier frame, the holder is configured to be engaged a foldable carrier of the child carrying device. The carrier frame has an unfolded state and a folded state. The holder has an effective position corresponding to the unfolded state and an ineffective position corresponding to the folded state. When the carrier frame is switched between the unfolded state and the folded state, the carrier frame drives the holder to switch between the effective position and the ineffective position.

In an embodiment of the present application, the carrier frame includes: a front leg frame; a handle frame pivotally connected to the front leg frame through a first pivot; and a support frame configured to support the front leg frame, the support frame being pivotally connected to the front leg frame through a second pivot. The holder is pivotally connected to the support frame through a third pivot. The handle frame is in sliding fit with the holder.

In an embodiment of the present application, the first pivot is close to an upper end portion of the front leg frame, and the second pivot is further away from the upper end portion of the front leg frame than the first pivot. And/or, the third pivot is close to an upper end portion of the support frame, and the second pivot is further away from the upper end portion of the support frame than the third pivot.

In an embodiment of the present application, one of the handle frame and the holder is provided with a connecting pin, and the other of the handle frame and the holder is provided with a sliding hole. The connecting pin is in sliding fit with the sliding hole.

In an embodiment of the present application, the connecting pin is arranged on the handle frame, and the connecting pin is further away from a lower end portion of the handle frame than the first pivot; and the sliding hole is arranged on the holder.

In an embodiment of the present application, the sliding hole includes an upper end and a lower end opposite to the upper end. When the carrier frame is in the unfolded state, the connecting pin abuts against an end wall of the upper end of the sliding hole to limit downward pivoting of the holder around the third pivot. When the carrier frame is in the folded state, the connecting pin moves to a lower end of the sliding hole.

In an embodiment of the present application, the sliding hole is in a shape of an arc. And/or, a cover plate is arranged on the holder. The cover plate covers the sliding hole on a side of the holder facing away from the handle frame.

In an embodiment of the present application, the holder is provided with a first engaging structure, the support frame is provided with a second engaging structure. When the carrier frame is in the unfolded state, the first engaging structure abuts against the second engaging structure to limit upward pivoting of the holder around the third pivot.

In an embodiment of the present application, the first engaging structure and the second engaging structure are a first step and a second step fitted with each other, or a first protuberance and a first recess fitted with each other.

In an embodiment of the present application, the holder is provided with an accommodating portion. The accommodating portion includes a bottom opening. The support frame extends into the accommodating portion via the bottom opening. The third pivot is supported by a sidewall of the accommodating portion. The first engaging structure is arranged in the accommodating portion.

In an embodiment of the present application, a third engaging structure is arranged on the bottom of the holder. The third engaging structure is arranged between the sliding hole and the third pivot. The handle frame is provided with a fourth engaging structure. When the carrier frame is in the unfolded state, the fourth engaging structure abuts against the third engaging structure.

In an embodiment of the present application, the third engaging structure is an engaging groove, and the fourth engaging structure is a post.

In an embodiment of the present application, the carrier frame further includes an underframe. A front end of the underframe is pivotally connected to a lower end of the front leg frame through a fourth pivot. The support frame is foldable, and a lower end of the support frame is pivotally connected to the underframe through a fifth pivot.

In an embodiment of the present application, the support frame includes an upper bracket and a lower bracket that are arranged in an up-down direction and are pivotally connected to each other. The upper bracket is pivotally connected to the front leg frame through the second pivot and pivotally connected to the holder through the third pivot. The lower bracket is pivotally connected to the underframe through the fifth pivot. When the carrier frame is folded, a pivot joint between the upper bracket and the lower bracket are moved backward so that the upper bracket and the lower bracket approach each other, the handle frame is rotated forward and downward to approach the front leg frame, and the front leg frame is rotated backward and downward to approach the underframe.

In an embodiment of the present application, a pair of the front leg frames, a pair of the handle frames, a pair of the upper brackets, a pair of the lower brackets, a pair of the holders, and a pair of the underframes are provided, and arranged on left and right sides of the carrier frame. Lower ends of the upper brackets on the left and right sides are connected by a first cross arm, and upper ends of the lower brackets on the left and right sides are connected by a second cross arm. The first cross arm is pivotally connected to the second cross arm.

According to a sixth aspect of the present application, a child carrying device includes a foldable carrier and the carrier frame according to any one of the above embodiments of the aspects.

In the child carrying device according to the sixth aspect of the present application, the foldable carrier may be the foldable carrier according to any one of the above embodiments of the aspects.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present application, and their description is specific and detailed, but cannot therefore be understood as a limitation on the patent scope of the invention. It should be noted that those of ordinary skill in the art may further make variations and improvements without departing from the conception of the present application, and these all fall within the protection scope of the present application. Therefore, the patent protection scope of the present application should be subject to the appended claims.

1. A foldable carrier, comprising:
a seat assembly;
an armrest assembly pivotable relative to the seat assembly and movable between a folded position and an unfolded position, the armrest assembly being provided with a locking portion;
a backrest assembly having a folded position and an unfolded position;
a linkage assembly movably connected to the backrest assembly; and
a locking member, one end of the locking member being pivotally connected to the linkage assembly, the other end of the locking member being capable of being fitted with the locking portion, the backrest assembly being folded in a direction approaching the armrest assembly, to drive, through the linkage assembly, the locking member to be separated from the locking portion.

2. The foldable carrier according to claim 1, wherein the linkage assembly comprises a driving member and a linkage member, one end of the linkage member being pivotally connected to the locking member, the other end of the linkage member being slidably connected to the driving member, and the driving member being pivotally connected to the backrest assembly.

3. The foldable carrier according to claim 2, wherein the driving member is provided with a driving groove arranged in a length direction of the driving member, and the other end of the linkage member is provided with a guide pin, and
wherein the guide pin is inserted into the driving groove and movable in the driving groove.

4. The foldable carrier according to claim 3, wherein the linkage assembly further comprises a first reset member arranged in the driving groove, and
wherein two ends of the first reset member respectively abuts against the guide pin and an inner wall of the driving groove.

5. The foldable carrier according to claim 4, wherein the backrest assembly comprises a fixing member, and
wherein the fixing member is pivotally connected to the seat assembly at a first pivot point, and the driving member is pivotally connected to the fixing member at a second pivot point, and the second pivot point is offset from the first pivot point.

6. The foldable carrier according to claim 5, wherein the linkage assembly further comprises a driving pin arranged on the driving member, and the driving member is pivotally connected to the fixing member through the driving pin.

7. The foldable carrier according to claim 5, wherein the seat assembly comprises a side plate, the fixing member is pivotally connected to the side plate at the first pivot point, the linkage assembly and the locking member are arranged on a side of the side plate facing away from the fixing member, the side plate is provided with a guide groove, and the driving pin extends through the guide groove to be pivotally connected to the fixing member at the second pivot point; and wherein the guide groove has a first position and a second position, the driving pin moves to the first position when the backrest assembly is in the folded position, and the driving pin moves to the second position when the backrest assembly is in the unfolded position.

8. The foldable carrier according to claim 7, wherein the guide groove is an arc groove bent around the first pivot point.

9. The foldable carrier according to claim 7, wherein the seat assembly further comprises a side cover, and
wherein the side cover covers a side of the side plate facing away from the fixing member to form an accommodating space, and the linkage assembly and the locking member are arranged in the accommodating space.

10. The foldable carrier according to claim 1, wherein the armrest assembly comprises an armrest support rod, the locking portion is a locking groove formed on the armrest support rod, and the locking member is a locking pin;
wherein the armrest support rod is pivotally connected to the seat assembly at a third pivot point, a first circle tangent to a bottom wall of the locking groove is drawn with the third pivot point as a center, and when the armrest assembly moves to the unfolded position, the locking pin is capable of being inserted into the locking groove in a radial direction of the first circle.

11-12. (canceled)

13. The foldable carrier according to claim 1, wherein the backrest assembly further comprises an angle adjustment mechanism configured to adjust an angle of the backrest assembly relative to the seat assembly.

14. The foldable carrier according to claim 13, wherein the angle adjustment mechanism comprises an angle adjustment locking member, the angle adjustment locking member being movably arranged on the backrest assembly, and wherein the seat assembly is provided with a plurality of locking holes, the angle adjustment locking member is capable of being fitted and locked into any one of locking holes, so that the backrest assembly is fixed at different angles relative to the seat assembly.

15. The foldable carrier according to claim 14, wherein the angle adjustment locking member has a first driving position and a second driving position, and
wherein, when the angle adjustment locking member is in the first driving position, the angle adjustment locking member is inserted into any one of the locking holes, and the backrest assembly is relatively fixed to the seat assembly; and when the angle adjustment locking member is in the second driving position, the angle adjustment locking member is withdrawn from the any one of the locking holes, and the backrest assembly is rotatable relative to the seat assembly.

16. The foldable carrier according to claim 14, wherein the angle adjustment mechanism further comprises an angle adjustment reset member, and
wherein the angle adjustment reset member constantly enables the angle adjustment locking member to move toward the first driving position.

17. The foldable carrier according to claim 14, wherein the angle adjustment mechanism further comprises an operating assembly and a driving assembly, and
wherein the operating assembly is operable to drive, through the driving assembly, the angle adjustment locking member to move toward the second driving position.

18. The foldable carrier according to claim 17, wherein the driving assembly comprises a rod member and a driving pin, and
wherein the rod member is provided with a driving slope, the driving pin is fixed to the angle adjustment locking member, and the driving pin abuts against the driving slope; wherein, when the driving assembly is operated, the rod member is movable and drives the driving pin to move by the driving slope, and drives the angle adjustment locking member to move toward the second driving position by the driving pin.

19. The foldable carrier according to claim 18, wherein the operating assembly comprises an operating handle, a pulling reset member, a connecting member, and a pulling member, and
wherein two ends of the pulling member are respectively connected to the connecting member and the rod member, the pulling reset member is arranged between the operating handle and the connecting member, the operating handle is operable to drive the connecting member to move by the pulling reset member and pull the pulling member by the connecting member, and the pulling reset member constantly enables the operating handle to move in a direction opposite to a direction in which the operating handle is operated.

20. The foldable carrier according to claim 1, wherein
the seat assembly comprises a seat body and a side plate;
the armrest assembly comprises an armrest support rod pivotable relative to the seat assembly; and
the backrest assembly comprises a backrest support assembly movably connected to the linkage assembly;
wherein two opposite sides of the seat body are each provided with the side plate, the armrest support rod, the backrest support assembly, the linkage assembly, and the locking member, and on either of the two opposite sides of the seat body, the backrest support assembly is pivotally connected to the side plate.

21. A child carrying device, comprising:
a carrier frame; and
the foldable carrier according to claim 1.

22. The child carrying device according to claim 21, wherein the child carrying device is a bassinet, a car seat, a bouncing chair, a child stroller, a high chair, or a child dining chair.

23-57. (canceled)
